(19) United States
(12) Patent Application Publication
(10) Pub. No.: US 2006/0004762 A1
(43) Pub. Date: Jan. 5, 2006

(54) Electronic release of information method and apparatus

(76) Inventors: Ross A. Berning, Madison, WI (US); Kyle N. Christensen, Fitchburg, WI (US); Steven J. Larsen, Cross Plains, WI (US); Scott Andrew Lordi, Madison, WI (US); Phillip A. Van Nortwick, Madison, WI (US); Somasekhar Sista, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/882,018

(22) Filed: Jun. 30, 2004

Related U.S. Application Data
(60) Provisional application No. 60/572,963, filed on May 20, 2004.

(51) Int. Cl. G06F 17/30

(52) U.S. Cl. 707/9

(57) ABSTRACT

A method for a health care provider to release health information in an electronic format to at least one third party client where the client employs a client information interface linkable via a network to a server associated with the health care provider, the method comprising the steps of providing a secure channel on the network to link the client interface to the server, posting a subset of health information as a release of information (ROI) on the network server for access over the secure channel by the client and notifying the client that a ROI has been posted for access.

### CROSS-REFERENCE TO RELATED APPLICATIONS

This application is related to provisional patent application No. 60/572,963 which was filed on May 20, 2004 and which has the same title as this application.

### STATEMENT REGARDING FEDERALLY SPONSORED RESEARCH OR DEVELOPMENT

Not applicable.

### BACKGROUND OF THE INVENTION

This invention relates generally to release of patient health or medical information and more specifically to a system and method for streamlining the process of identifying and releasing health information to third parties that require access to information of specific types.

Whenever a patient meets with a doctor or has a medical/diagnostic procedure performed, one or more records are often generated that correspond to the specific appointment or procedure. While these records are generated for future use by the specific doctor and staff or health care provider associated with the meeting or procedure, these records may also be required by any of several other parties. For example, health insurance companies often need copies of records to verify that meetings/procedures have occurred and to pay out claims. As another example, when an injury leads to legal action, a lawyer may need copies of medical/health records related to a patient's health both before and after an accident occurred.

As yet one more example, where a patient uses several doctors and one or more of the doctors are not affiliated with a facility at which original records are generated, the unaffiliated doctors may nevertheless require copies of the medical records associated with the patient and controlled by the facility to provide the most informed medical advice possible. Hereinafter, unless indicated otherwise, a medical facility that controls a record will be referred to as a “record controlling entity” or an “RCE” and the phrase “third party client” or term “client” will be used to refer generally to any party that the RCE does not want to provide full access to the RCE's databases to and-that requests a record from the RCE.

In many cases current procedures and systems for maintaining medical records and obtaining medical record copies have several shortcomings. First, current record archiving processes often require a large amount of facility space. To this end, many RCEs store hard copies (i.e., paper and film) of medical records in large storage spaces, typically within RCE facilities themselves. For instance, in many cases an entire basement space within a facility is used to store catalogued paper copies of medical records.

Second, the process by which a third party client obtains record copies from an RCE often takes a long time. In this regard, in many cases when a client requires a medical record from a medical facility, the client has to provide a request for the specific record to the RCE. When an RCE receives a request, a records employee charged with managing RCE records typically performs a manual or semi-manual process to glean information from the request to determine the client's identify, the patient for which information is sought, the type of information sought and the sub-set of information sought. Next, the records employee identifies a file that should include the record including the information requested by the client and locates the file. After a record is retrieved, the employee makes copies of the portions of the record required by the client and then, pursuant to record audit guidelines adopted by many RCEs, places an entry on the record file indicating the date/time the copies were made, the third party client's identity and what section of the record was copied. The employee then replaces the hard copy record in the archive and mails or faxes the record copy to the third party client. In many cases the process above takes several days to more than a week to complete.

Third, release authorization requirements can, under certain circumstances, further prolong the record delivery process. To this end, most medical records and information are highly confidential and patients associated therewith only want the information released on an as-needed basis and, even when information is released, would prefer that only the information required by a requesting party be released. To accommodate patients and meet regulatory requirements, RCE typically enforce strict guidelines such that health/medical records cannot be released unless release has been authorized by the patient or, in some cases, a doctor or nurse (i.e., an agent) that treats the patient associated with the record. Where authorization to release has been pre-obtained, often information indicating authorization to release is placed on a file associated with a record. In these cases, when a record is retrieved by an RCE records employee, the employee confirms that release is authorized prior to making the requested copies. Where release has not been authorized, the employee may need to seek authorization prior to release thereby further slowing the record delivery process.

Fourth, because current record maintenance and retrieval processes are labor intensive and require excessive amounts of storage space, they are relatively expensive. In this regard, RCE space is relatively expensive and storing hard copies of records is costly. Moreover, while the process of retrieving and providing record copies described above may not appear too burdensome where a copy is required for a single record, in the case of a large RCE, it is not uncommon for the RCE to receive several hundreds or even thousands of record requests weekly. To process large numbers of record requests quickly, many RCEs employ a team of personnel that maintain record archives and that receive and fill record requests. Thus, many records departments struggle with the tasks required to provide records to requesting parties.

Fifth, where record retrieval, authorization verification, auditing and copying are manual, errors have been known to occur. For instance, a records employee may retrieve a record, erroneously determine that release to a specific client has been authorized and mail a copy of the record to the client. As another instance, while a client may be authorized to receive information in a record requested, the records employee may copy a wrong section of a record for mailing. As still one other instance, despite RCE audit guidelines, in some cases a records employee may forget to indicate when a copy is made and sent to a third party client or may erroneously record information regarding a copy provided to a client. Other errors are contemplated and have been know to occur.

Sixth, some times, despite a record being mailed to a recipient, circumstances result in there being a question regarding whether or not the mailed record was reviewed by the client and if the record was reviewed, by whom the record was reviewed. Here, for instance, insurance companies may refuse to pay claims when required medical records are not received by deadlines.

Seventh, in many cases only a portion of a record may be required to fulfill the needs of certain record clients. Where only a sub-set of the information on a record is required to meet a client's needs, most patients prefer that only the needed record information be released (in fact, some regulations specify that only needed information be released when requested). While this preference is understandable, determining which information on a record should be released to specific clients may be difficult and therefore require more highly trained records employees. In addition, meeting these preferences is time consuming and could lead to additional errors where records employees incorrectly determine which parts of records are required to meet client's needs.

Eighth, as with all hard copies of information, hard copies of record requests and of delivered records can be inadvertently misplaced. When a hard copy of a record request is misplaced by a records employee, often the delay that results is excessive. To this end, when a record request is misplaced, often the client will assume that the request is still being processed by the RCE and the RCE records employee may have no knowledge that the request was ever received. Similarly, when a hard copy of a record is misplaced by a client after delivery, the delivery delay is exacerbated. When a record is misplaced, often the client will assume that the request is still being processed by the RCE and the RCE records employee assumes that the request-has been filled. Misunderstandings regarding request status have been known to linger on for several weeks at a time. When a client finally recognizes that a record has been misplaced, the request process described above has to be repeated again in its entirety thereby further delaying delivery of the required record.

To deal with some of the problems described above the medical records industry has developed electronic record retention (ERR) systems where, as the label implies, patient records are stored electronically. An exemplary ERR system includes one or more servers and databases and some type of information interface (e.g. a personal computer, a laptop, hand held device (e.g., a palm computing device), etc.) where the servers, databases and interfaces are linked via a communication network. The servers run programs that help records employees identify specific records that are requested by third party clients. For instance, an exemplary program may include several fields for entering specific types of information such as patient name, dates, times, a physician's name, a specific treatment or diagnosis, etc. The servers also run programs to access specific records and to provide at least a subset of the record information to the records employee via the interface. In these cases, once a record is accessed via an interface, the employee can print out a copy of the record to be mailed or otherwise securely delivered to the client.

By storing records electronically, storage space can be reduced substantially. In addition, it is far easier and less time consuming to identify, access, review and render a copy of an electronic record than it is to perform a similar process using hard copy records.

Despite having many advantages, current ERR systems still have not addressed several of the problems described above including the archaic way in which record requests are issued and in which records are securely delivered to clients, the problems associated with misplaced requests and/or misplaced delivered records, the inability to audit when a record has been reviewed by a client that received the record, inefficiency, wasted paper, missed deadlines, human error, inaccuracy of information disclosed (wrong information, too much information, too little information), fixed information formats, information redacting problems (e.g., where information in addition to requested information exists on a record, the information may have to be blacked out, etc.

One seemingly attractive solution to issuing record requests and delivering records in a more timely fashion that could eliminate some of the problems described above would be to issue requests and deliver records via e-mail. Unfortunately, because of the sensitive nature of many patient health records, government regulations require that record requests and medical records that include information useable to identify specific patients (e.g., by name, social security umber, etc.) be distributed in a secure fashion or via a secure channel (e.g., via encryption or a point-to-point communication architecture, etc.). Because of the way in which e-mails are communicated, e-mail is not considered confidential/secure and therefore, unfortunately, e-mail cannot be used to issue requests and deliver records.

Thus, it would be advantageous to have a system whereby sensitive health records/information could be delivered to RCE clients in a secure and timely fashion. In addition, it would be advantageous to have a system that streamlines the record requesting process, the record accessing process and the process of identifying and generating parts of records that are required by specific clients. Moreover, it would be advantageous to have a system that could at least streamline the process of determining if clients are authorized to access specific records and that could generate an audit trail for all information requested and/or released.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It has been recognized that delivery of sensitive health information can be facilitated by providing secure network channels for use by clients that require the sensitive information and posting the sensitive information for access over the secure channels. It has also been recognized that the requesting process can be streamlined in at least some cases by allowing information requests to be made over the secure channels. Moreover, it has been recognized that in at least some cases where requests are made over the secure channels, various processes can be automated for identifying the information sought, determining if the requesting client has authority to access the information sought, seeking authorization when authorization does not exist, generating releases of information (ROIs), posting the ROIs and creating access logs for each ROI that occurs.

Consistent with the above comments, according to at least one aspect of the present invention, the invention includes a method for a health care provider to release health information in an electronic format to at least one third party client where the client employs a client information interface linkable via a network to a server associated with the health care provider, the method comprising the steps of providing a secure channel on the network to link the client interface to the server, posting a subset of health information as a release of information (ROI) on the network server for access over the secure channel by the client and notifying the client that a ROI has been posted for access.

In some cases the method further includes the steps of, prior to posting, receiving a ROI request from the client requesting information associated with a specific patient and identifying an information subset at least associated with the information requested via the ROI request.

In some cases the at least one third party client includes a plurality of third party clients, each client having access to a client interface, the step of posting the ROI including providing a separate client account on the server that is accessible via the secure channel for each of the third party clients and posting the ROI for access on the client account page via the secure channel. Here, the client may generate more than one ROI request and the step of posting the ROI on the account page may include providing a list of posted ROIs for the client on the account, each list entry including a reference phrase (e.g., a hypertext phrase, a selectable icon or any other visually selectable marking) which, when selected, links the client to additional information associated with the posted ROI.

In some embodiments the step of notifying the client includes transmitting an electronic message to the client prompting the client to access the client account via the secure channel. The step of transmitting an electronic message may include transmitting an e-mail to the client. The step of transmitting an e-mail may include embedding hyperlink text in the e-mail that, when selected by the client, links the client to a log-on page for accessing the client account.

The step of notifying the client may include transmitting an electronic message (e.g., an e-mail) to the client prompting the client to access the client account via the secure channel. The step of transmitting an e-mail may include embedding a reference phrase in the e-mail that, when selected by the client, links the client to a log-on page for the for accessing the client account.

In some cases the step of transmitting an e-mail includes embedding a reference phrase in the e-mail that, when selected by the client, links the client directly to the ROI including the requested information. In some cases the step of posting includes posting the ROI for a predetermined period, the method further including the step of, after the ROI has been posted for the predetermined period, rendering the ROI inaccessible to the third party client.

The step of receiving an ROI request may include entering the ROI request via the client interface and transmitting the ROI request over the secure channel to the server. The at least one client may includes a plurality of clients, each client having access to a client interface, the step of receiving further including the steps of providing a separate client account on the server that is accessible via the secure channel for each of the third party clients and providing a ROI request window via the server on each of the client accounts that is accessible by an associated client over the secure channel via the associated client interface. The method may further include the step of providing at least one authorization window requiring a client to enter identifying information prior to accessing the client account.

In some cases the method further includes the steps of storing access information associated with each third party client having a client account maintained by the server, when a client enters identifying information, comparing the entered information with the access information, when the entered information matches access information associated with at least one of the third party clients having an account maintained by the server, providing access to the client account. Here there may be several different ROI types and each client is authorized to access at least one ROI type wherein the step of storing access information includes storing ROI types accessible by each client with client identifying information. Here, after an ROI request is entered, the step of identifying an information subset may include the information requested includes the steps of identifying an ROI type associated with the ROI request and identifying the information subset as a function of the associated ROI type.

The method further includes the step of, when an ROI request is received, storing an indication of the request in at least some embodiments. The step of storing an indication may include generating a ROI access log indicating instances of associated ROI requests. The step of storing an indication may include storing the time of the ROI request. The ROI request may indicate the identity of the client and the step of storing an indication includes storing the identity of the client. The step of storing an indication may also include storing the time at which the request was received and other information such as type of request and related data, etc.

The method may also include the step of, when a ROI is posted, storing an indication of the posting. Here, the step of storing an indication may include generating an access log indicating instances of associated posted ROIs. The step of storing an indication may include storing the time of the posting. The step of storing may also include storing the time at which the record is posted.

The method may also include, after posting the ROI, monitoring access to the posted ROI. Here, the step of monitoring may include, whenever the client accesses the posted ROI, storing an indication that the ROI was accessed. The step of storing an indication may include, for at least each ROI accessed, generating an access log indicating instances of associated ROI access. The step of storing an indication may include storing the time at which the ROI is accessed. The step of storing an indication may include storing the identity of the client that accessed the ROI. The step of storing also may include storing at least one of the time at which the ROI is accessed and the duration over which the ROI is accessed.

In at least some embodiments there are a plurality of third party clients and each client has access to a client interface and only a subset of the clients is authorized to access at least one information subset and wherein the method further includes the step of, prior to posting a ROI including information requested, determining if the client is authorized to access the ROI including the information requested. The method may further including the steps of, when a client requests an information subset that the client is not authorized to access, performing a secondary function. The step of performing a secondary function may include generating a reject notice indicating that the client is not authorized to access the requested information subset. The reject notice may indicate at least a subset of the identity of the rejected client, the time of the request and the information requested.

In at least some cases it is contemplated that at least one employee of the health care provider may have access to an employee information interface linkable to the server and the reject notice may be provided to at least one of the client via the client information interface and the at least one employee via the employee interface.

When the reject notice is provided to the employee, the method may further include the step of enabling the employee to authorize release of the information requested by the ROI request and when the employee authorizes release the information requested, posting at least a subset of information associated with the ROI request for access by the client over the secure channel via the client interface. Here, the step of enabling may include requiring the employee to indicate the source of authorization via the employee information interface and storing the source of authorization.

In some cases at least one of the patient associated with the information sought via the ROI request and an agent for the patient may have access to a patient information interface that is linkable to the server associated with the health care provider and the secondary function may include seeking authorization to release the information requested via the ROI request from the at least one of the patient and the agent via the patient interface. Here, the at least one of the patient and the agent may have a patient account maintained by the server that is accessible via the secure channel and the step of seeking authorization may include generating an electronic authorization request and posting the request to the patient account (e.g., via MyChart^{R} software provided by Epic Systems, Inc., of Madison Wis.).

The method may further including the steps of, after seeking authorization, monitoring for a return authorization from the at least one of the patient and the agent, when a return authorization is received, storing the authorization and posting at least an information subset associated with the ROI request for access by the client over the secure channel.

At least some embodiments of the invention also include a method for a health care provider to release health information in an electronic format to third party clients where each client employs a client information interface linkable via a network to a server associated with the health care provider, the method comprising the steps of providing secure channels on the network to link the client interfaces to the server, for each client, providing a separate client account via the server accessible only over the secure channel and only by the client associated with the account for which the page is provided and for each client account, electronically posting at least a subset of information associated with the information requested by the client associated with the account as a release of information (ROI) for access over one of the secure channels.

In addition, at least some embodiments of the invention include a method for a health care provider to release health information in an electronic format to at least one third party client where the client has access to a client information interface linkable via a network to a server associated with the health care provider, the method comprising the steps of providing a secure channel on the network to link the client interface to the server, receiving a release of information (ROI) request from a third party client requesting information associated with a specific patient, identifying at least a subset of information associated with the information requested via the ROI request, placing the identified information subset in an electronic format and posting the identified information subset as a release of information (ROI) on the network for access by the client over the secure channel.

Moreover, some inventive embodiments include a method for tracking when health care information is accessed by a third party client having access to a client information interface that is linked by a network to a sever, the method comprising the steps of providing a secure channel on the network to link the client interface to the server, electronically posting a subset of health care information as a release of information (ROI) via the server for access over the secure channel, monitoring access to the posted ROI by the third party client, when the ROI is accessed by the third party client, identifying at least a subset of the time the ROI is accessed, the identity of the person accessing the ROI, the duration of access and whether or not a hard copy of the ROI is generated and storing at least a subset of the time the ROI is accessed, the identity of the person accessing the ROI, the duration of access and whether or not a hard copy of the ROI was generated as part of a ROI access log.

Furthermore, some embodiments include a method for providing notice to a patient when a health record associated therewith is requested by a third party client where the patient has access to a patient information interface that is linked to a communication network having a secure channel, the method comprising the steps of monitoring when records are requested by a client and when a record associated with a specific patient is requested by a client, transmitting a notice to the patient interface.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a schematic diagram illustrating a system including a secure communication channel for delivering information to requesting parties via a communication network;

FIG. 2 is an exemplary records database table that may form part of the records database of FIG. 1;

FIG. 3 is an exemplary release type database that may form part of the records database of FIG. 1;

FIG. 4 is a method for releasing requested ROIs via a secure network account to a requesting party;

FIG. 5 is an exemplary screen shot that may be provided by the server of FIG. 1 to facilitate at least some aspects of the present invention;

FIG. 6 is an exemplary screen shot that may be provided by the server of FIG. 1 to facilitate an ROI search according to one aspect of the present invention;

FIG. 7 is an exemplary screen shot that may be provided by the server of FIG. 1 to facilitate entry of information that defines an ROI request;

FIG. 8 is a flow chart illustrating an exemplary method by which a ROI requesting party may access ROIs via a secure account;

FIG. 9 is an exemplary screen shot that may be provided to a requesting party to facilitate access of released ROIs;

FIG. 10 is an exemplary screen shot that may be provided to a requesting party and that is associated with a specific ROI;

FIG. 11 is an exemplary screen shot that may be provided to a records employee for specifying a time period over which an ROI will be released;

FIG. 12 is a subprocess that may be used to enhance the method of FIG. 4 to enforce a ROI time period;

FIG. 13 is a matter ROI log database that may be included as part of the records database 20 of FIG. 1;

FIG. 14 is a subprocess that may be added to the process of FIG. 4 to facilitate at least one aspect of the present invention;

FIG. 15 is a subprocess that may be added to the method of FIG. 4 to facilitate another aspect of the present invention;

FIG. 16 is an exemplary authorization database that may form part of the records database of FIG. 1;

FIG. 17 is a method according to another aspect of the present invention whereby a ROI requesting party can directly submit an electronic ROI to the server of FIG. 1 to obtain a ROI;

FIG. 18 is a screen shot that may be provided to a requesting party via a secure channel to facilitate entry of an ROI request from the party directly to the server of FIG. 1;

FIG. 19 is a submethod that may be used to enhance the method of FIG. 17 such that when a requesting party is not authorized to obtain a requested ROI, the server of FIG. 1 automatically provides the request to a records employee for further processing;

FIG. 20 is a submethod which, like the submethod of FIG. 19, may be used to enhance the method of FIG. 17 such that authorization to release is automatically sought from a patient associated with the ROI request;

FIG. 21 is a screen shot illustrating an exemplary audit trail window that may be provided for either a client or a records employee;

FIG. 22 is a subprocess that may be added to portions of the processes of FIGS. 4 and 17 to provide a hybrid process according to one aspect of the present invention;

FIG. 23 is an exemplary screen shot similar to the screen shot of FIG. 7, albeit illustrating an authorized and released ROI form;

FIG. 24 is a screen shot illustrating a revoke access window according to at least one aspect of the present invention; and

FIG. 25 is a subprocess that may be added to the process of FIG. 4 to implement a revoke access function.

### DETAILED DESCRIPTION OF THE INVENTION

Several specific embodiments of the present invention are described below. It should be appreciated that in the development of any actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

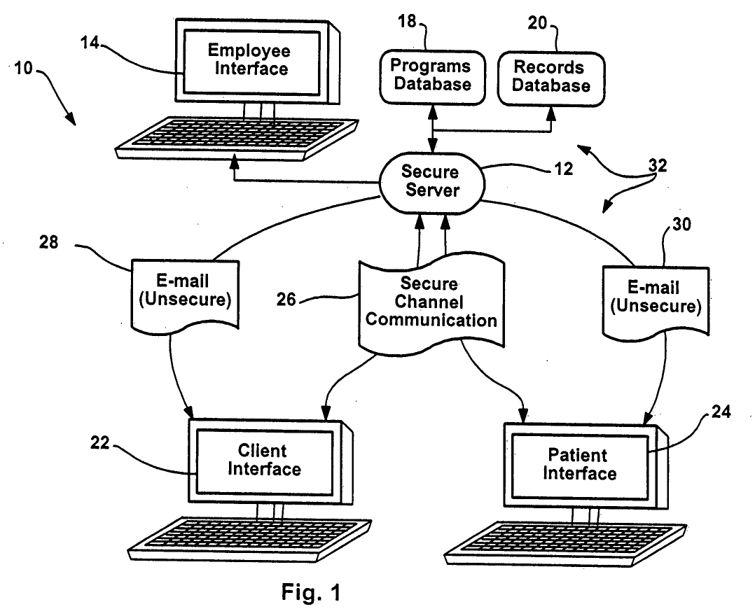

In the description that follows the networked system described has been simplified in order to simplify the present explanation and it should be appreciated that far more complex systems are contemplated. For instance, the system 10 of FIG. 1 is described as including a single server 12, a single client interface 22, a single patient interface 24, etc. while more practical systems will likely include many of each of these components. As another instance, while two databases 18 and 20 are described, clearly most modern network systems include many interlinked databases for storing data and application programs.

Referring now to the drawings wherein like reference numbers correspond to similar elements throughout the view and, more specifically, referring to FIG. 1, the present invention will be described in the context of an exemplary networked computer system 10 including a secure server 12, several interfaces (e.g., personal computers, workstations, etc.) including an employee interface 14, a client interface 22 and a patient interface 24, databases 18 and 20 and a network identified generally by numeral 32 which includes unsecured channels for communication such as, for instance, e-mail channels 28 and 30 and a secure communication channel 26. Network 32 links server 12 to the employee interface 14 as well as to databases 18 and 20. In addition, network 32 links server 12 to each of the client interface 22 and the patient interface 24 for both secure and unsecure communication.

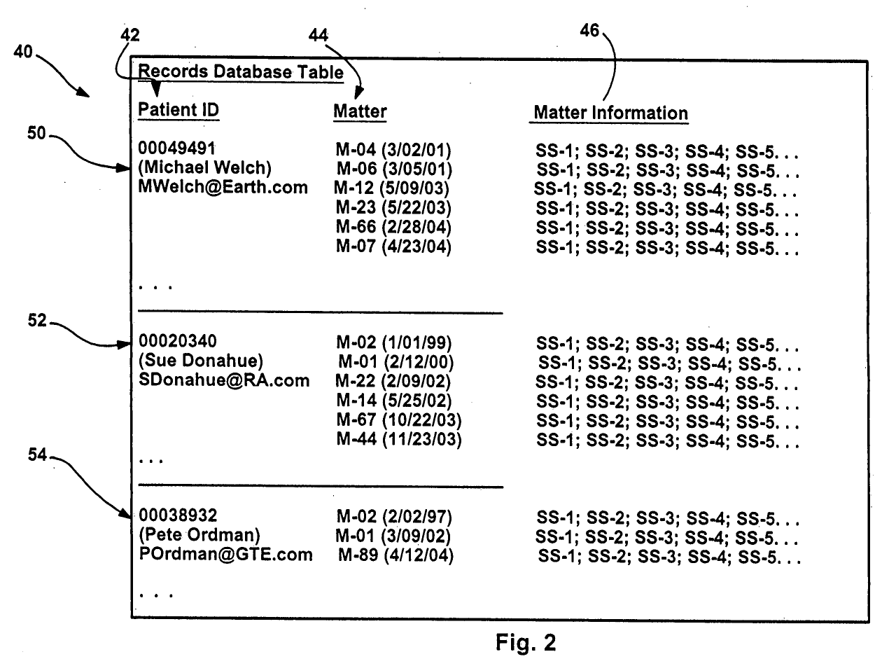

Referring still to FIG. 1, records database 20 stores a plurality of different information subsets which are accessible via server 12. The stored information subsets may include any type of information associated with a medical procedure or process, demographic information, access/authorization information, a ROI access log, etc. Referring also to FIG. 2, an exemplary information database table 40 that may be stored in database 20 is illustrated that lists all of the matters associated with each patient for which information is maintained on database 20, dates associated with the matters and subsets of information associated with the matters. To this end, table 40 includes a patient ID column 42, a matter column 44 and a matter information column 46. As illustrated, patient ID column 42 includes a separate entry for each patient for which records are stored on database 40. In FIG. 2 only three patient entries 50, 52 and 54 are illustrated. Nevertheless, it should be appreciated that, in many cases, several thousand or even million patients will be listed in a database like database 40. The patient identifying information provided in column 42 includes a patient ID number and a patient's name. For instance, the patient identification information corresponding to entry 50 includes a patient ID number 49491 which corresponds to Michael Welch (hereinafter “patient Welch”).

Matter column 44 indicates one or a subset of matters corresponding to each of the patient identification entries (e.g., 50) in column 42 where a matter is associated with a specific event or related group of events. For instance, one exemplary matter may include an office visit to a particular doctor. As another instance, a matter may include all information related to a specific accident that resulted in injury to an associated patient identified in column 42. Exemplary matters in column 44 are identified by an “M” followed by a number to distinguish one matter from another. Thus, for instance, listed matters for patient Welch include matters M-04, M-06, M-12, M-23, M-66 and M-07.

Referring still to FIG. 2, matter information column 46 lists subsets of information that are associated with a corresponding matter in column 44. Information subsets in column 46 are identified by an “SS” label followed by a number that distinguishes one information subset from the others. Information subsets may include any one or a subset of physical characteristics of a patient, patient allergies, medical diagnosis, symptoms, medical images, information regarding a diagnostic or treatment visit, physicians or nurses that attended to a patient during a visit, a patient's social security number, information regarding a patient's appearance, notes or observations by a physician, etc. Here, it is contemplated that information regarding a matter is stored as separate but correlated information subsets that can be cobbled together to form any of several different types of reports or records. For instance, one record type may be for an insurance company that provides enough information for the company to pay a claim. Here the information required may be very minimal and therefore only a small number of the information subsets for a request would be required. As another instance, another record type may be required pursuant to a law suit in which case detailed information may be required. In this case a more complete group of the information subsets may be cobbled together to generate a record. Hereinafter, unless indicted otherwise, a record or set of information that is rendered available to a requesting party will be referred to as a release or a release of information (ROI) unless indicated otherwise.

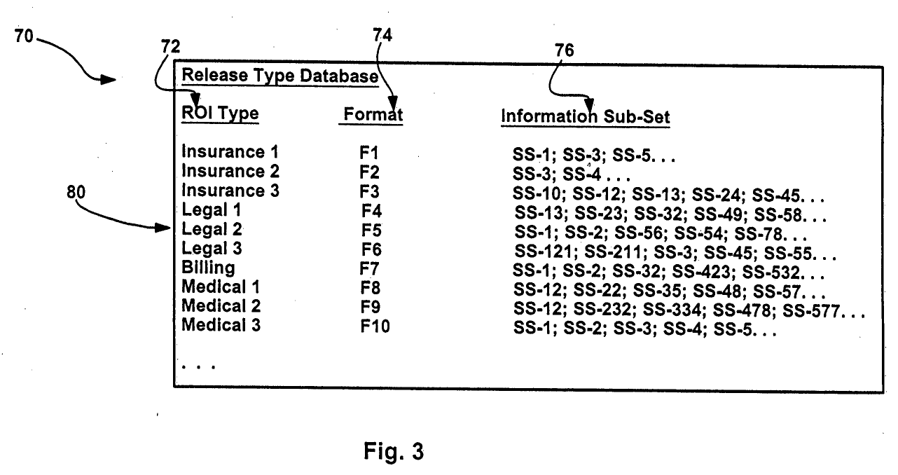

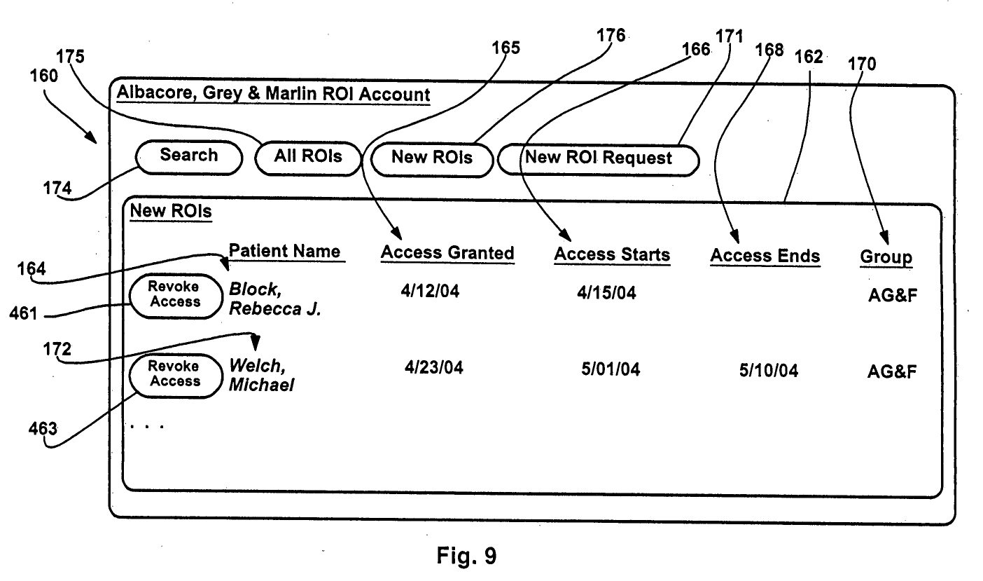

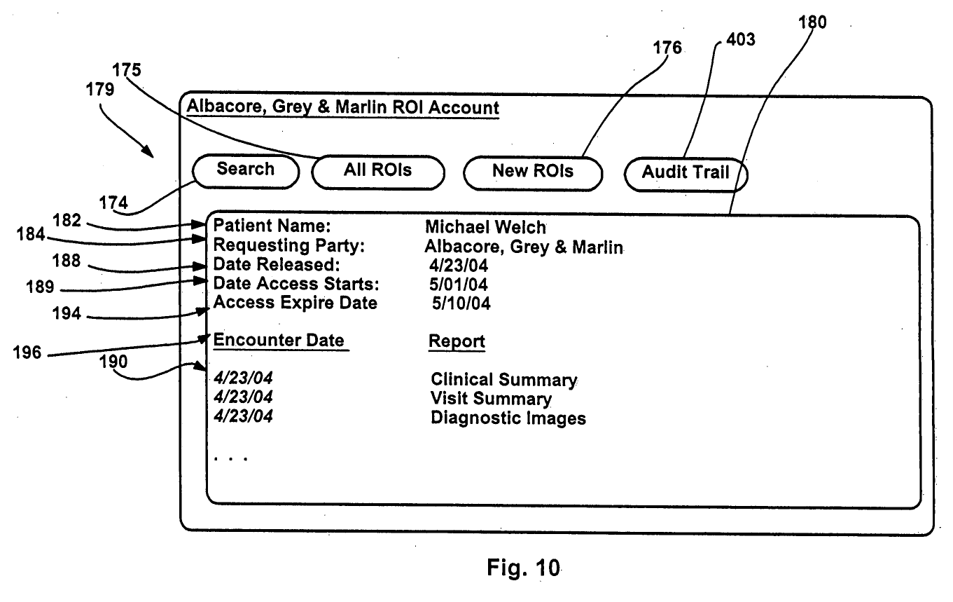

Referring now to FIG. 3, an exemplary release type database 70 is illustrated which indicates different record or ROI types supported by system 10 of FIG. 1, different sets of the information subsets to be included in each one of the release types and format information for formatting the information subsets. To this end, release type database 70 includes three columns including a ROI type column 72, a format column 74 and an information subset column 76. ROI type column 72 lists each one of the release types and, exemplary release types include “Insurance 1”, “Insurance 2”, “Legal 1”, “Legal 2”, and so on. Format column 74 lists a separate format for each one of the ROI types in column 72. For example, format F1 defines a record format for the ROI type Insurance 1 in column 72. Similarly, format F5 defines a format for the ROI of type Legal 2 in column 72, and so on. Although not illustrated, the format information will indicate how information in associated information subsets is to be organized when presented via an interface display screen or when printed) as well as specifying fonts, colors, hyperlink addressing if supported, and so on. Exemplary views of formatted ROI screenshots are shown in FIGS. 9 and 10 discussed below.

Information subset column 76, as its label implies, indicates a separate set of the information subsets (see again column 46 in FIG. 2) that are to be used to populate or instantiate a record of the corresponding format in column 74. For example, for a record having the format F1 in column 74, information subsets used to populate the record format F1, as indicated in column 76, include subsets SS-1, SS-3, SS-5 and, likely, would include additional information subsets not listed in FIG. 3.

Referring once again to FIG. 1, the programs database 18, as its label implies, includes programs that cause server 12 to perform various methods. The programmed methods may include processes that facilitate entry of a ROI request, to identify information subsets required to generate a ROI, to cobble information subsets together to form a ROI, to post records for access by clients and to perform various other methods described hereinafter.

To help illustrate aspects of the present invention, an exemplary record request will be assumed throughout the following specification. To this end, referring once again to FIG. 2, it will be assumed that patient Welch was involved in an accident (hereinafter “the accident”) that occurred on Apr. 23, 2004 and that patient Welch was treated at North Family Practice Medical Facility (hereinafter “the NFP facility”) on the day the accident occurred. It will also be assumed that on the same day of the accident, patient Welch retained an attorney Robert Jones (hereinafter “Attorney Jones”) of the law firm Albacore, Grey & Marlin (hereinafter “AGM”) to represent patient Welch, that Attorney Jones has access to a client interface 22 (see again FIG. 1) at his firm and that his firm has previously established an account with the NFP facility that is set up on server 12 whereby Attorney Jones can securely access (eg., via a secure channel) ROIs posted by the NFP facility on the AGM account in response to ROI requests.

In the description that follows simplified screen shots including window views (hereinafter “windows”) are used to illustrate exemplary methods. It should be appreciated that, in at least some embodiments, it is contemplated that far more complex and detailed screen shots and windows may be provided that include many more functional icons (i.e., mouse controlled cursor selectable icons) and that the stripped down versions are provided here in order to simplify this explanation.

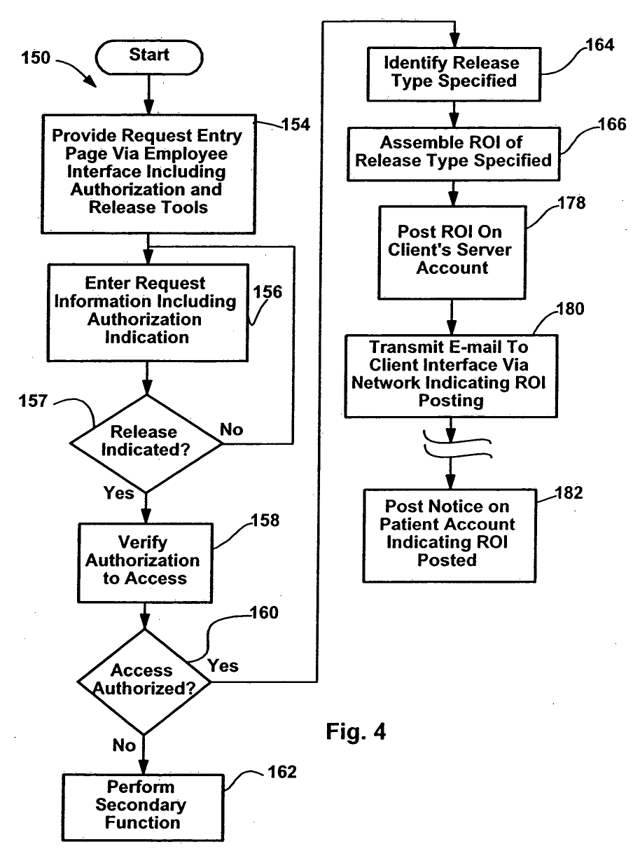

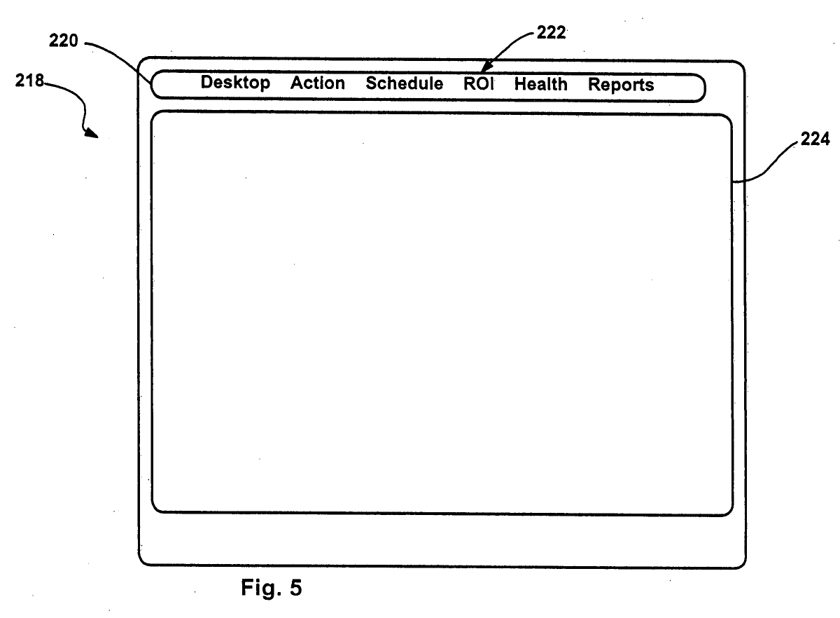

Referring now to FIG. 4, an exemplary method 150 according to one aspect of the present invention is illustrated. Prior to the process steps in FIG. 4, in this example, it will be assumed that Attorney Jones faxed a ROI request to the NFP facility requesting accident information associated with the accident. It will also be assumed that a records employee responsible for managing NFP facility records has received the ROI request from Attorney Jones. Referring to FIGS. 1 and 4, at process block 154, when the records employee logs on to system 10 via the employee interface 14, server 12 provides a request entry page via interface 14 including both authorization and release tools. To this end, referring to FIG. 5, when the employee logs on to system 10, server 12 first provides a home page including a tool bar 220 along the top of the window 218 and a workspace 224. Tool bar 220 lists a plurality of mouse/cursor selectable icons including, for the purposes of the present invention, a ROI icon 221. Work space 224 includes a space in which information associated with an application selected via tool bar 220 is provided and is initially blank. In at least some contemplated embodiments when ROI icon 221 is selected, an ROI request application is started.

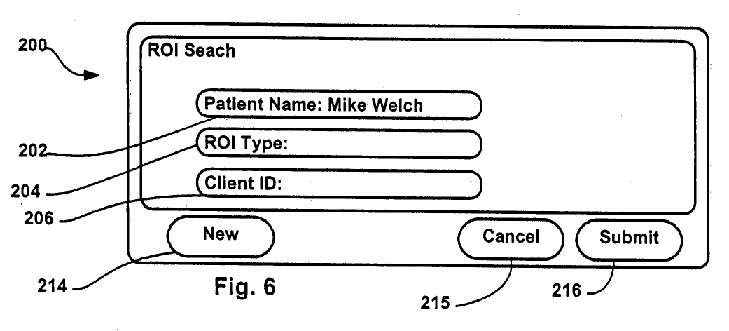

Referring also to FIG. 6, when ROI icon 221 is selected, a separate ROI search window 200 is opened. ROI search window 200 can be used in two ways. First, ROI search window 200 can be used to search for previously specified ROI requests, both released and unreleased (i.e., forms with at least partial information specified that have not been released for some reason—e.g., pending authorization to release). Second, ROI search window 200 can be used to gain access to a blank ROI form so that a new ROI request can be entered by the records employee.

To search existing ROIs, the records employee fills in fields within the ROI search window 200 and then submits the search request by selecting a SUBMIT icon 216. Where the information filled into the ROI search window fields does not match an existing ROI, server 12 simply indicates that no match occurred. Where one existing ROI matches field information, server 12 provides the existing ROI including the previously filled in information. To this end, an exemplary unreleased ROI 251 including filled in information is illustrated within workspace 224 of FIG. 7. The exemplary unreleased ROI 251 will be described in greater detail below. Where more than one existing ROI matches the information filled into the ROI search window fields, server 12 simply provide a list of the matching existing ROIs and allow the records employee to select one of the matching ROIs for further processing.

Referring still to FIG. 6, to access a blank ROI form usable to enter a completely new record request, the records employee selects NEW icon 214. When icon 214 is selected, a blank ROI form like the form 251 illustrated in FIG. 7 is provided. CANCEL icon 215 can be selected to return to home page 218 illustrated in FIG. 5.

Referring still to FIG. 6, the ROI search window fields include a patient name field 202, a ROI type field 204 and a requesting party field 206. The records employee may enter a patient's name in field 202. Where known, the employee may enter the type (e.g., Insurance 1, Legal 2, etc.) of ROI sought in field 204. The requesting party's name and/or identifier can be entered into field 206 where known. Here it should be noted that many other search fields may be included as part of the ROI search window to more specifically specify ROIs being sought and which fields to include in window 200 is a matter of designer choice. In all cases where information is being entered, the processor may look for matching content in its databases and attempt to recognize errors and/or matches that can be suggested to the information entering person to help aid the person in identifying records. Such a matching process may be accomplished by use of an Enterprise Master Person Index (EMPI) such as the Identity^{R} EMPI product offered by Epic Systems, Inc., or by other similar means.

Referring now to FIG. 7, once a ROI request form (e.g., 251) is accessed within workspace 224, the records employee can fill in the ROI request form fields as appropriate to specify a specific patient, a specific requesting party, a release type, the dates for which information is being sought including a beginning date and an ending date, comments regarding the information sought as well as other information when appropriate. To this end, exemplary ROI request form 251 includes a patient name field 236, a release type field 238, a “From Date” field 242, a “To Date” field 244, a “Client ID” field 246 and a comments field 248. Again, many other ROI specifying fields are contemplated and which fields to include in form 251 is a matter of designer choice.

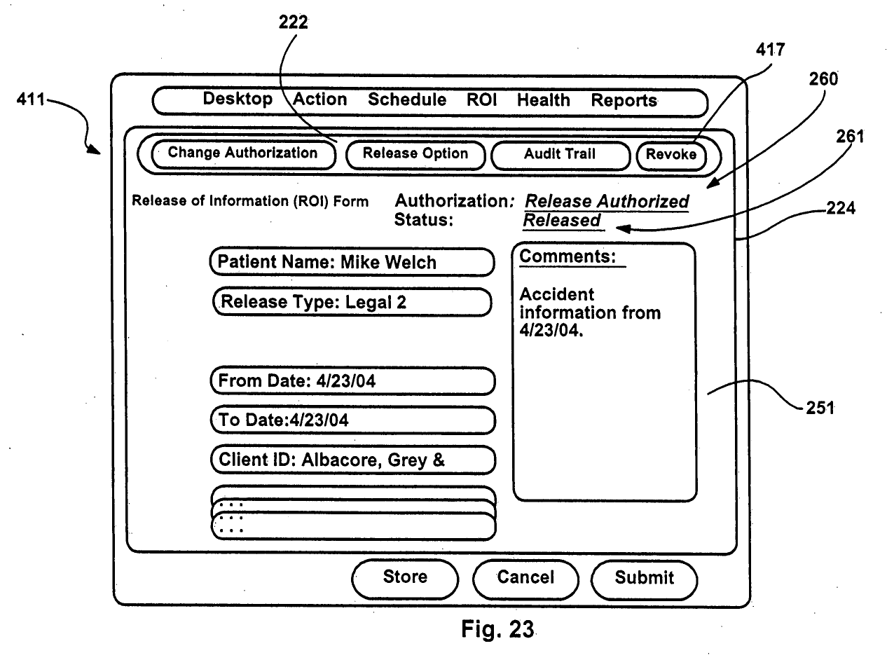

In addition to including fields for receiving entered information, various control icons are provided within workspace 224. For instance, some tool icons are provided within an ROI tool bar 222 at the top of workspace 224 including, among others, a “Change Authorization” icon 230. Herein, the term “Authorization” is used to refer to whether or not a requesting party has been authorized to receive a specific set of information being sought. Where authorization has not been stored in database 20, the phrase “Release Not Authorized” is provided in an Authorization field 260 just below ROI tool bar 228 and near the right hand edge of the workspace 251. Where the requesting party has already been authorized to receive information being sought, the status in field 260 is “Release Authorized” as illustrated in FIG. 23. The employee is capable of modifying the authorization indication by selecting icon 230 and using associated tools (not illustrated) that allow the status to be modified. In at least some embodiments system 10 will require the records employee to provide some suitable indication of the source of authorization when authorization is indicated such as, for instance, a form signed by a patient or an attending physician. Once the status of an ROI has been changed to authorized, field 260 is updated to indicate “Release Authorized” (not illustrated).

A status field 261 is provided just below Authorization field 260 that indicates if a ROI has been released. Where the ROI has not been released, field 261 indicated “Not Released” as illustrated in FIG. 7. After a ROI has been released field 261 indicates “Released” as illustrated in FIG. 23.

Referring still to FIG. 7, in addition to functional tool bar 222, CANCEL, STORE and SUBMIT icons 258, 257 and 256 are provided below workspace 224, respectively. CANCEL icon 258 can be selected to return to the ROI home page of FIG. 5. STORE icon 257 is selectable to store an unreleased ROI for subsequent release (e.g., prior to obtaining authorization to release). SUBMIT icon 256 is selectable to submit the ROI request specified by form 251 to server 12 in FIG. 1.

Referring once again to FIG. 4, block 156 represents entry of information into the ROI request form 251. At block 157, server 12 monitors the records employee interface to determine when SUBMIT icon 256 has been selected thereby submitting an ROI request to server 12. If SUBMIT icon 256 has not been selected, control loops back up to block 156 where the records employee may modify information on the ROI request form. At block 157, after SUBMIT icon 256 has been selected, control passes to block 158.

At block 158, server 12 determines whether or not the ROI requested by the records employee has been authorized for release. At block 160, where a ROI request has not been authorized for release, control passes to block 162 where server 12 performs a secondary function. Here, in at least some cases, the secondary function may include indicating to the records employee via interface 14 that access has not been authorized. Other secondary functions are contemplated, several of which are described hereafter.

If, at block 160, access has been authorized, control loops to block 164 where server 12 identifies the release type specified via the ROI request form. Next, at block 166, server 12 assembles a record including information consistent with the ROI request. To this end, server 12 accesses release type database 70 (see again FIG. 3) and the records database table (see FIG. 2). In the present example, referring again to FIG. 7, the specified release type is Legal 2 and therefore, using the release type database 70, server 12 identified the format (e.g., F5) from column 74 and the information subsets from column 76 that are associated with the ROI type Legal 2.

Next, server 12 identifies the patient and matter in database table 40 that is specified in the ROI request. In the present example the patient is patient Welch (designated by number 50) and the matter is M-07 that occurred on Apr. 23, 2004. Continuing, server 12 instantiates or fills in the ROI format F5 with the information from column 46 that is associated with matter M-07 and that is specified by column 76 (see again FIG. 3) thereby generating the requested ROI. At block 178, the requested ROI is posted on the AGM server account. Continuing, at block 180, server 12 transmits an unsecure e-mail to the client interface 22 via network 32 indicating that a record has been posted that can be accessed via the Albacore, Grey & Marlin account maintained by the NFP facility.

Here, while the un-secure e-mail cannot include patient identifying information, the e-mail may include other information that can be used to distinguish one ROI from others. For instance, the e-mail notice may identify Attorney Jones and the date that the request was submitted.

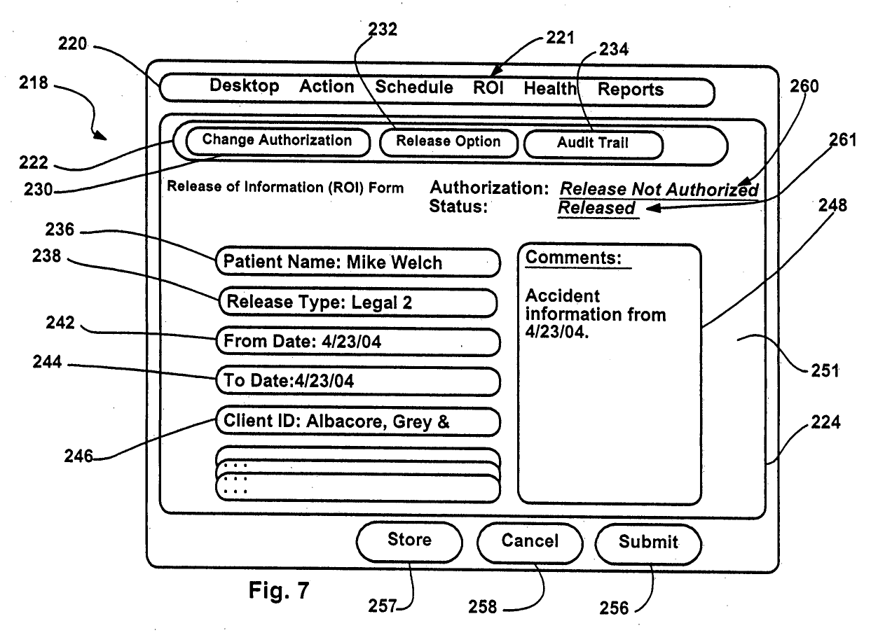

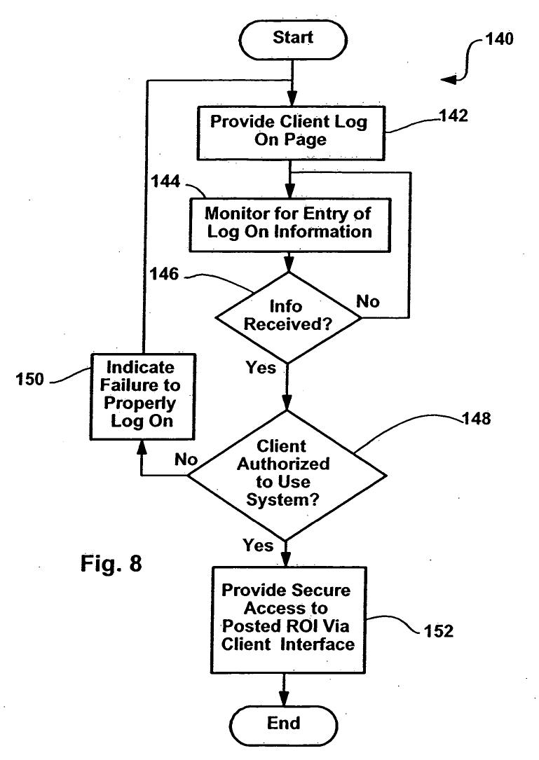

Referring now to FIG. 8, an exemplary method 140 by which the requesting party can access a posted record is illustrated. Referring also to FIG. 1, at block 142, Attorney Jones uses client interface 22 to access the ROI web portal provided by server 12. At block 144, server 12 monitors the portal for entry of log on information by a client. Exemplary log-on information may include a user name and a password. At block 146, where log on information has not been provided control loops back up to block 144. Once log on information has been provided by a client, control loops from block 146 to block 148 where server 12 determine whether or not the client is authorized to use the system. Where the client is not authorized to use the system, control passes to block 150 where server 12 indicates failure to properly log on. After block 150 control loops back up to block 142 where the process described above is repeated. At block 144, if a client is authorized to use the system, control passes to block 152 where server 12 provides secure access via a secure channel 26 to ROIs posted on the specific requesting party's account.

Consistent with the present example, after Attorney Jones successfully logs on to the ROI web portal, server 12 provides the AGM account via interface 22 used by Attorney Jones. To this end, referring to FIG. 9, an exemplary account ROI home page 160 is illustrated which includes a list of new posted ROIs requested by Attorney Jones. The posted ROIs are provided in a table format 162 that includes, among other things, a patient name column 164, an access granted column 165, an access starts column 166 and a Group column 170. Patient name column 164 lists the names of patients associated with specific posted records. Consistent with the present example patient Welch's name 172 appears in column 164. The Granted and Starts columns 165 and 166 indicate the dates on which access is granted and starts, respectively. Group column 170 indicates the entity associated with the account accessed—in the present case AGM.

In addition to listing the newly released ROIs, page 160 may include other mouse/cursor selectable control icons including a SEARCH icon 174, an ALL ROIs icon 175 and a NEW ROIs icon 176. SEARCH icon 174, in at least some contemplated embodiments, will be selectable to search either new or all ROIs that are posted via an account for a specific ROI. ALL ROIs icon 175 is selectable to provide a table similar to table 162 that lists all ROIs posted on an account. NEW ROIs icon 176 is selectable to provide table 162. Other functional icons are contemplated and which ones to include on an account home page is a matter of designer choice.

In at least some embodiments it is contemplated that each of the separately listed new ROIs in table 162 will be selectable to access more detailed ROI information (e.g., the requested ROI itself). For instance, in the present example, the posted new ROIs are accessed by selecting a patient's name (e.g., Welch, Michael) which is presented as a reference phrase that is visually distinguished (e.g., red or blue color) from other table 162 information and that is hyperlinked to an associated ROI.

Referring now to FIG. 10, when reference phrase “Welch, Michael” is selected, server 12 provides a window 179 including the associated ROI 180 via the client interface 22. The exemplary ROI 180 includes information indicating the patient 182, the requesting party 184, the date released 188, the date access starts 189 and other information as well as substantive information 190 specified by the format F5 (i.e., the Legal 2 format) and the associated information subsets specified in column 76 of release type database 70. In FIG. 10 the substantive information is shown in summary table format including reference phrases (e.g., dates) to specific substantive information. Many other ROI formats for providing substantive information are contemplated and which formats to support via system 10 are a matter of designer choice.

According to another aspect of the present invention, when a ROI is posted for access by a requesting party on the party's account, in at least some cases, it is contemplated that it may be advantageous to restrict ROI access to a specific time period. For example, in some cases record access may be restricted to 10 days while in other cases access may be restricted to a longer period such as an entire month. Referring once again to FIG. 7, in addition to including CHANGE AUTHORIZATION icon 230, ROI tool bar 222 also includes a RELEASE OPTION icon 232.

When icon 232 is selected, in at least some embodiments, window 270 illustrated in FIG. 11 is provided which allows the records employee to indicate a period over which an associated ROI will be accessible by a requesting party. Window 270 includes two fields 272 and 274 in which the first and last days of an accessing period are to be entered, respectively. In the present example, the first day of the access period is identified as May 1, 2004 and the last day of the access period is identified as May 10, 2004. A comments field 276 is provided in which the records employee may provide comments regarding the period specified in fields 272 and 274. In addition to fields 272, 274 and 276, window 270 includes CANCEL and SUBMIT icons 278 and 280, respectively. CANCEL icon 278 can be used to cancel the period specification and to return to the ROI form illustrated in FIG. 7. When SUBMIT icon 280 is selected, in at least some embodiments the ROI form or request will be submitted to server 12. In other embodiments, when SUBMIT icon 280 is selected, the ROI request form of FIG. 7 will again be provided and submission of the request will only occur after SUBMIT icon 256 is selected.

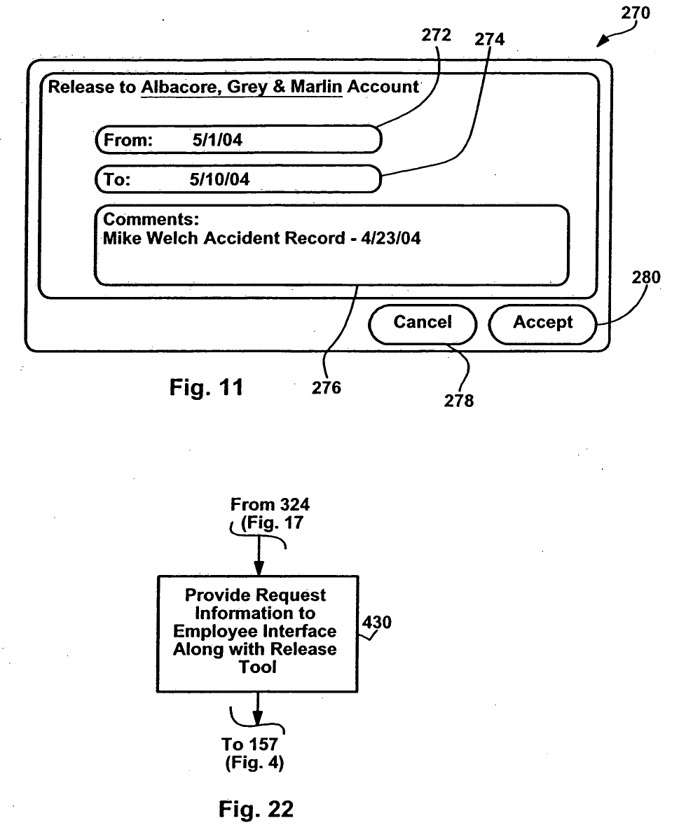

Referring now to FIG. 12, an exemplary sub-method 199 that may be substituted for a portion of the method of FIG. 4 for enforcing an access period is illustrated. Referring also to FIG. 4, after an ROI has been instantiated at block 166, control passes to block 200 in FIG. 12. At block 200, server 12 identifies the initial time Ti and end time Te of the release period specified by the records employee. Next, at block 202, server 12 compares the current time to the initial time Ti. Where the initial time has not yet occurred, control loops back up through block 202. After initial time Ti occurs, control passes to block 204 where the ROI sought by the ROI request is posted on the client account. At block 206, an e-mail is transmitted to the client via client interface 22 and network 32 that indicates that an ROI has been posted. At block 420, server 12 compares the current time to the end time Te for the release period. Once the end time Te occurs, control passes to block 422 where server 12 renders the ROI inaccessible via the client account.

Referring again to FIG. 9, in at least some cases the new ROI table 162 will include an Access Ends column 168 that indicates when access to a particular ROI expires. In the present example access to the ROI associated with patient Welch 172 expires on May 10, 2004. Similarly, in at least some cases the ROI itself will include an access expiration date (see 194 in FIG. 10).

In at least some embodiments it is contemplated that where an access expiration time is near and a ROI has not been accessed by a client, server 12 may be programmed to transmit supplemental e-mail to remind the requesting client that the ROI has been posted and that access will expire shortly. For instance, if an access period is 10 days and a ROI has not bee accessed by the eight day of the access period, a reminder e-mail may be sent to the requesting client. Similarly, after a posted record has expired, instead of simply eliminating the posted record, the system may provide information indicating that the record was posted and when access to the record expired. Other information may also be included with the “Expired” notice including the time the record was requested, the nature of the request and the dates during which the record was posted.

According to one other aspect of the present invention, server 12 may be programmed to maintain a ROI log for each of the ROIs requested by a third party client. To this end, various types of information associated with each request may be recorded. For example, the date and time a request is released by a records employee may be recorded. Similarly, the date and time a record is posted or released for access by a client, the date and time a ROI is accessed by a client, the person accessing a ROI, the duration of access, whether or not a ROI has been printed, etc., may all be recorded.

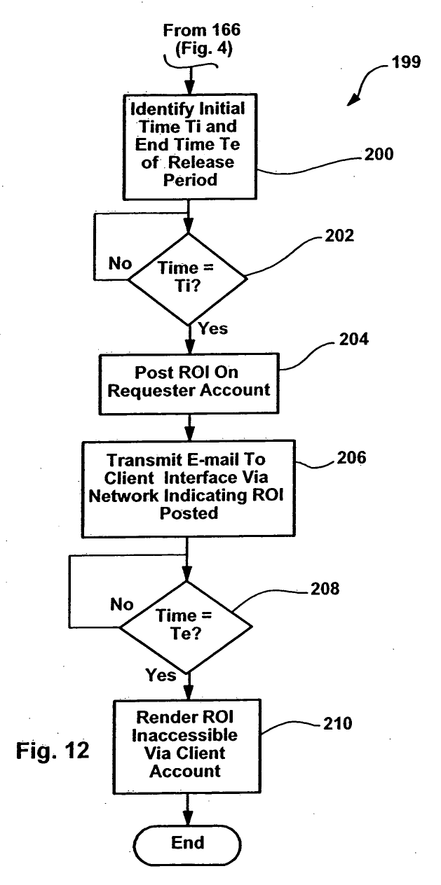

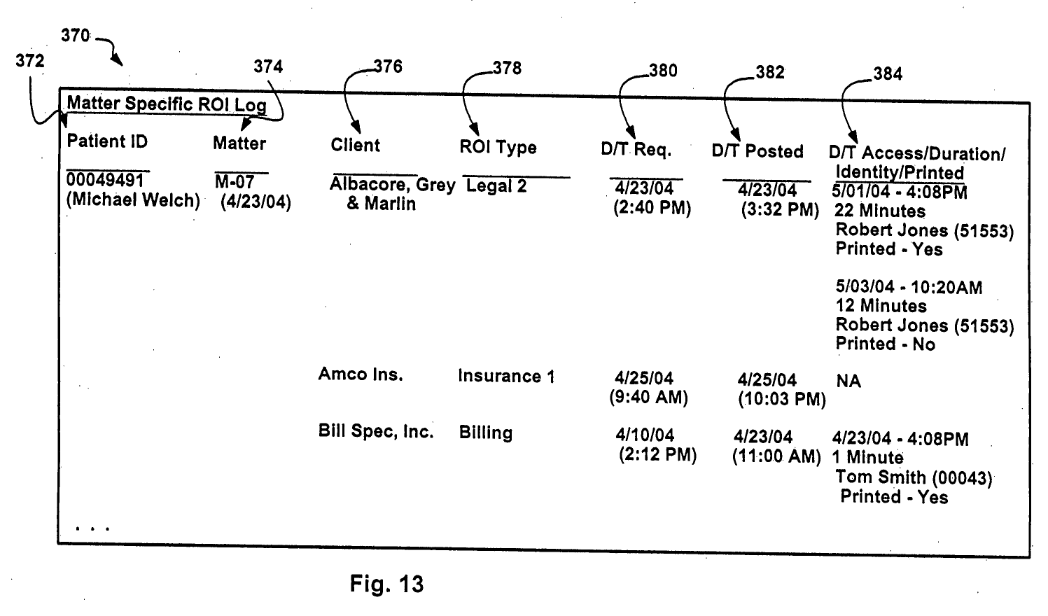

Referring now to FIG. 13, an exemplary matter specific ROI log 370 that may be maintained by server 12 is illustrated. ROI log 370 includes a Patient ID column 372, a Matter column 374, a Client Identification column 376, a Record Type column 378, a Date/Time Requested column 380, a Date/Time Posted column 382 and a Client Activities column 384. The Patient ID column 372 identifies the patient for which the log 370 is being maintained. Consistent with the present example, patient Welch is identified in column 372.

Matter column 374 identifies the matter for which log 370 is being maintained. Here, matter M-07 is identified in column 374. Column 376 lists the identity of each client that has requested any type of ROI associated with the matter in column 374. For example, in the present case, column 376 lists AGM, Amco Inc. and Bill Spec, Inc., indicating that each of three separate parties requested at least some type of ROI associated with matter M-07 in column 374.

Continuing, ROI Type column 378 indicates the type of ROI requested by each client identified in column 376. Again, consistent with the present example, the type of ROI requested by AGM is the Legal 2 type. Date/Time Requested column 380, as its label implies, lists the date and time at which a records employee submitted a request for the ROI corresponding to the matter in column 374 by the client in column 376. Similarly, Date/Time Posted column 382 indicates the date and time an ROI was posted or released for access via the account associated with the client identified in column 376.

Client Activities column 384, at its label implies, lists several types of information that provide a history of access by the client identified in column 376. To this end, exemplary column 384 indicates a date and time at which a client accessed the released ROI (e.g., May 1, 2004—4:08 p.m.), the duration over which the ROI was accessed (e.g., 22 minutes), the person who accessed the ROI (e.g., Attorney Jones) and whether or not the ROI was printed when accessed (e.g., in the present example, when the ROI was accessed on May 1, 2004, log 370 indicates that the ROI was printed). Column 384 indicates that Attorney Jones accessed the posted ROI twice, once on May 1, 2004 and a second time on May 3, 2004. Where a record has not been accessed, log 370 indicates no access by placing a NA in column 384. Thus, despite the ROI having been posted for Amco Ins. on Apr. 25, 2004, that ROI has not been accessed.

Referring now to FIG. 14, an exemplary one step subprocess that may be used to enhance the method of FIG. 4 for generating at least a portion of the matter specific ROI log 370 is illustrated. To this end, referring also to FIG. 4, after a ROI has been released on a clients account at block 178, control passes to block 242 where server 12 updates the ROI log 370 (see again FIG. 13) to indicate that an ROI has been posted. After block 242, control passes back to block 180 in FIG. 4 where the process described above continues.

Referring now to FIG. 15, a subprocess 401 which may be substituted for block 152 in FIG. 8 to generate at least a portion of the ROI log information described is illustrated. To this end, when a client is authorized to use the system at block 148 in FIG. 8, control passes to block 253 in FIG. 15 where server 12 provides the list of new posted ROIs via the client interface. At block 255 server 12 monitors whether or not the client has selected one of the listed ROIs. Where the client has not selected one of the ROIs, control loops back up to block 253. After one of the posted ROIs has been selected, control passes to block 257 where server 12 updates the ROI log 370 (see again FIG. 13) to indicate that the selected ROI has been accessed. Next, at block 259, server 12 provides the requested ROI via the clients interface 22. Here, although not illustrated, server 12 may be programmed to monitor the access time, to identify and record the identity of the person using the interface 22 and to determine whether or not the ROI has been printed thereby generating additional information for log 370.

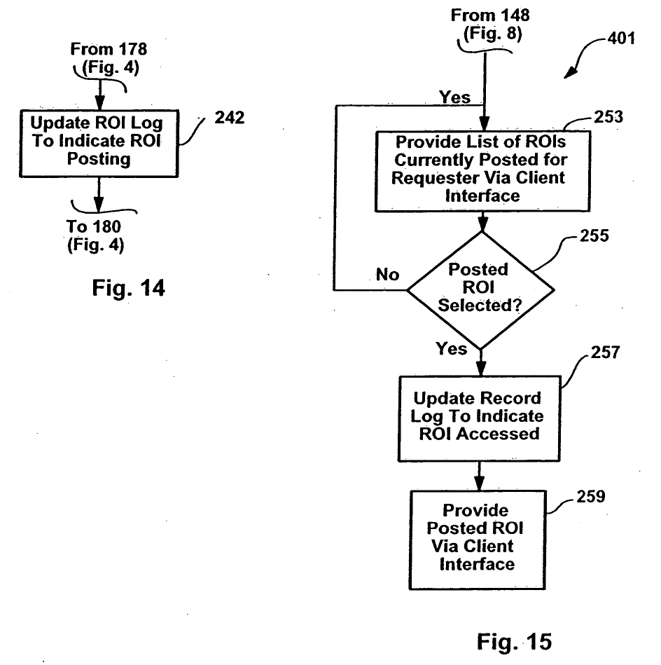

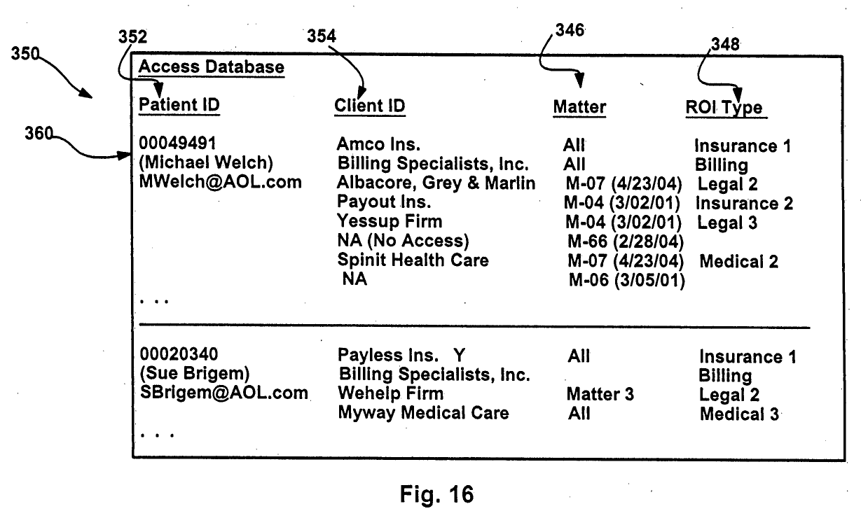

According to yet one additional aspect of the present invention, in at least some cases, it is contemplated that a requesting party may use a secure channel to request ROIs directly from server 12 thereby eliminating the need for records employees to act as intermediatories to enter ROI request information. To this end, it is contemplated that, in addition to the databases and tables described above, an access database may be included with the records database 20. To this end, an exemplary, albeit simplified, access database 350 is illustrated in FIG. 16. Access database 350 includes a patient ID column 352, a client ID column 354, a matter column 346 and a record type column 348. Patient ID column 352 lists each of the patients associated with the NFP facility for which at least one third party is authorized to obtain at least some information associated with at least one matter. Consistent with the present example, patient Welch is identified at 360 in column 352.

Client identification column 354 indicates each client that has been authorized to access at least some information corresponding to at least one matter associated with a patient identified in column 352. The AGM firm is identified in column 354 as being authorized to obtain at least some information corresponding to at least one matter associated with patient Welch.

Column 346 lists one or more matters for which each one of the clients in column 354 is authorized to obtain at least some information. For example, matter M-07 is identified as a matter for which the AGM firm is authorized to obtain at least some information. In some case, an “All” designation may be provided in column 346 indicating that the client associated therewith in column 354 is authorized to access at least some information corresponding to all of the matters associated with the patient identified in column 352. For example, in the illustrated database 350, Amco Ins. is authorized to obtain at least some information corresponding to all matter associated with patient Welch.

Continuing, column 348 lists one of the ROI types for each of the client and matter combinations specified by columns 354 and 346, respectively. Again, consistent with the present example, ROI type Legal 2 is specified for the combination of AGM and matter M-07 in columns 354 and 346, respectively.

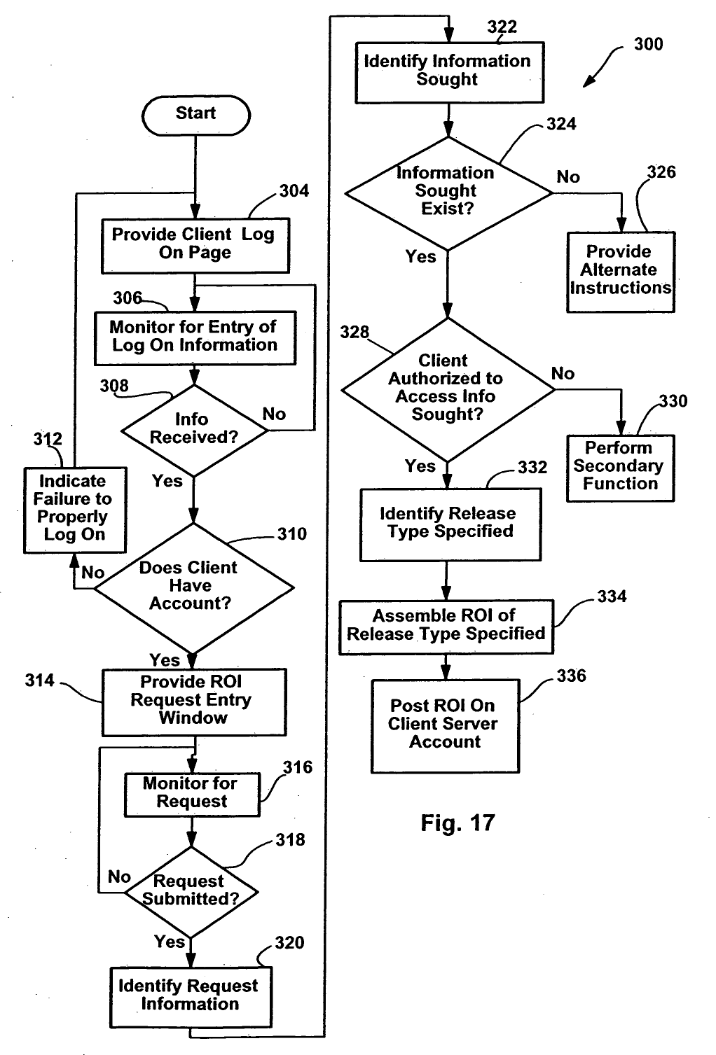

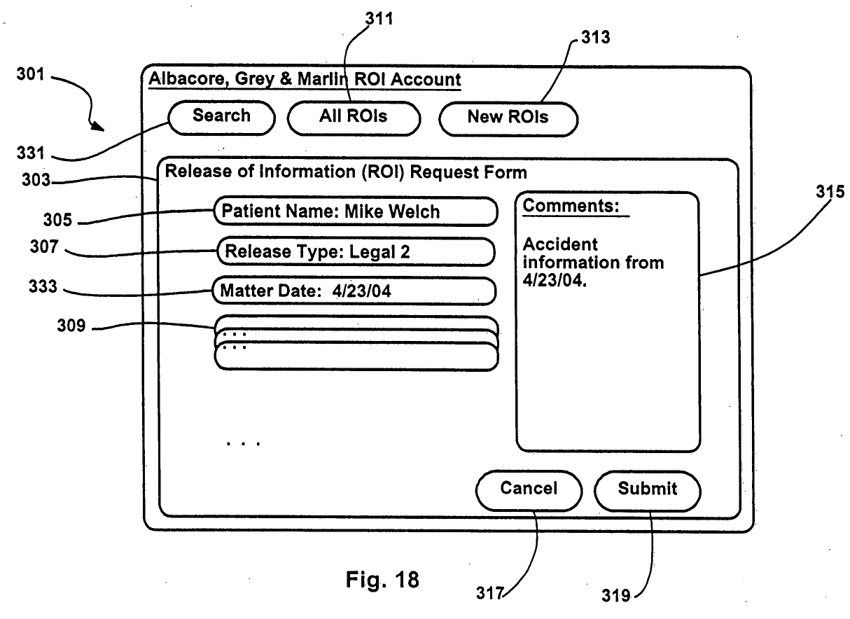

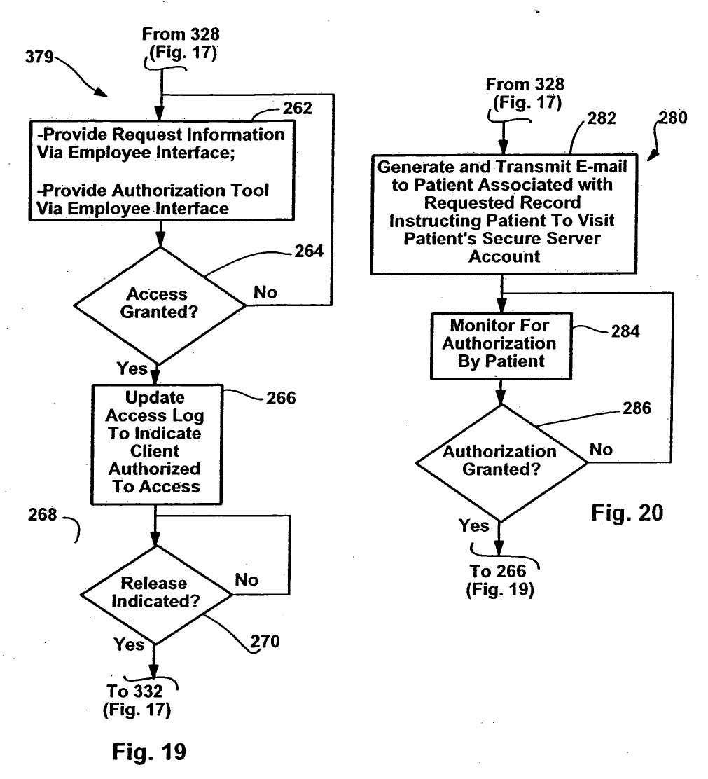

Referring now to FIG. 17, an exemplary method 300 that facilitates client generation and submission of an ROI request via a secure channel is illustrated. Referring also to FIG. 1, when a client accesses the secure ROI web portal provided by server 12, server 12 first provides a client log-on page at block 304. At block 306 server 12 monitors for entry of log-on information. At block 308 log-on information has yet to be received, control passes back up to block 306. After log-on information (e.g., user name and password) has been received, control passes from block 308 to decision block 310.

At block 310 server 12 determines whether or not the client has a ROI account supported by server 12. Where the client does not have an account, control passes to block 312 where server 12 indicates failure to properly log-on to the system. If the client does have an account at block 310, control passes to block 314 where server 12 provides an ROI form/request entry page. To this end, referring once again to FIG. 9, upon accessing the clients account, the client may be provided with the ROI home page 160 including a NEW ROI REQUEST icon 171. When icon 171 is selected, server 12 may provide an ROI request entry form or window similar to form 251 illustrated in FIG. 7.

An exemplary client ROI request window 301 is illustrated in FIG. 18. Window 301 includes an entry form 303 that includes a plurality of fields 305, 307, 309, 315, etc., for entering information that specifies an ROI request. Exemplary fields include a patient name field 305, a release type field 307, a matter date field 333 and a comments field 315. Fields 309 are provide to indicate that additional information may be specified by a requesting party in at least some embodiments. In addition to including entry fields, form 303 includes a CANCEL icon 317 and a SUBMIT icon 319 which, as their labels imply, can be used to cancel a request and return to the ROI home page (see again FIG. 9) or to submit a request to server 12, respectively. Window 301 also includes SEARCH, ALL ROIs and NEW ROIs icons 331, 311 and 313, respectively, that operate in a fashion similar to the same icons described above with respect to FIG. 9.

Referring still to FIGS. 1 and 17, at block 316 server 12 monitors the secured network to determine when a request is submitted. At block 318, when a request has not been submitted, control loops back up to block 316. After a request has been submitted at block 318, control passes to block 320 where server 12 identified requested information and at block 322 server 12 identifies the information sought via the request. At block 324, server 12 determines whether or not the information sought exists. For instance, in the present example, if Attorney Jones misspelled patient Welch's name, the information sought by Attorney Jones would not match information stored in database 20 (see again FIG. 1). As another instance, where Attorney Jones enters the wrong date into matter date field 333, when the ROI request is submitted, information sought would not exist.

If the information sought does not exist, control passes to block 326 where server 12 provides an alternate set of instructions to the user. For example, the alternate instructions may indicate that no information is available that corresponds to the ROI request. In the alternative, the alternate instructions may indicate that the requesting party should contact a records employee working for the NFP facility to obtain the requested information. This second alternative set of instructions will, in most cases, be optimal as the instructions do not indicate whether or not the information sought exists.

When the information sought at block 324 does exist, control passes to block 328 where server 12 determines whether or not the requesting party is authorized to access the information sought. Where the party is not authorized to access the information sought, control passes to block 330 where server 12 performs a secondary function. For example, secondary function at block 330 may be to simply indicate that the client is not authorized to access the information sought. Other secondary functions 330 are contemplated and described below. Where the client is authorized to access the information sought control passes to block 332.

Referring still to block 328, a client may not be authorized to access the information sought for a variety of reasons. For instance, the client may simply not be authorized to access any information corresponding to a specific patient. As another instance, the client may be authorized to access some information corresponding to a specific patient but not associated with a specific matter. To this end, referring again to FIG. 16, while the AGM firm is authorized to access information corresponding to matter M-07, AGM is not authorized to access information corresponding to other matters. Here, where Attorney Jones enters the date corresponding to matter M-04 into date field 333 (see again FIG. 18) instead of the date corresponding to matter M-07, authorization would be denied at block 328. As yet one other instance, if Attorney Jones indicates a release type in field 307 for which AGM is not authorized, authorization would be denied at block 328.

Referring still to FIGS. 1 and 17, at block 332, server 12 identifies the release type specified by the ROI request. At block 334 server 12 assembles a ROI of the release type specified and at block 336 server 12 posts the released ROI on the clients account.

According to still another aspect of the present invention, in the context of a system that allows a requesting party to directly provide a request to server 12 for an ROI, when a client is not authorized to access specific information sought, the server 12 may be programmed to provide rejected ROI requests to a records employee for further consideration. To this end, an exemplary subprocess 379 that may be substituted for the secondary function 330 in FIG. 17 is illustrated in FIG. 19. Referring also to FIG. 17, when a requesting party is not authorized to access information sought via an ROI request at block 328, control passes to block 262 where server 12 provides request information via the records employee interface 14 along with an authorization tool. To this end, referring once again to FIG. 7, a screen shot similar to screen shot 218 may be provided including the CHANGE AUTHORIZATION icon 222. Here, it is contemplated that the records employee can manually determine whether or not an ROI has been authorized by reviewing a paper file or other release that may have been provided by a patient or, in at least some cases, taking steps to obtain authorization to release information. At block 264, if the records employee uses icon 222 to grant authorization to release the ROI requested, control passes to block 266.

At block 266 server 12 updates the authorization database (see again 350 in FIG. 16) to indicate that the requesting party is authorized to access the ROI. At block 270, processor 12 monitors ACCEPT icon 256 to determine whether or not the records employee has authorized release of the ROI. Once the ROI is released, control passes from block 270 back to block 332 in FIG. 17 where the process described above continues.

Referring now to FIG. 20, one additional subprocess 280 that may be substituted for the secondary function block 330 in FIG. 17 is illustrated. Process 280 is an automated process whereby server 12 automatically attempts to obtain authorization for an ROI release from a patient when a requesting party has not previously been authorized to access specific information. To this end, referring once again to FIG. 17 and also to FIG. 1, if a client is not authorized to access information sought at block 328, control passes from block 328 to block 282 in FIG. 20 where server 12 generates and transmits an e-mail to the patient associated with the requested ROI instructing the patient to visit the patient's secure server account. To this end, referring again to FIG. 2, patient indicators (e.g., 50) may also include e-mail addresses for patients and, here, it is contemplated that each patient would have access to his own secure patient account that is maintained by server 12.

Next, at block 284, server 12 monitors the patient's secure server account for authorization by the patient to release a requested ROI. To this end, although not illustrated, it is contemplated that when the patient accesses the patient's secure server account, a notice will be provided via the secure account that indicates that a specific party has requested a specific set of information corresponding to a specific matter for the patient and requesting that the patient authorize release of the information. In addition, the ROI requested may be provided for the patient to review prior to granting authorization. Here, the patient will have the option to either grant authorization to release or to deny authorization to release. Where the patient authorizes release at block 286, control passes to block 266 in FIG. 19 where the process described above continues.

According to yet one other aspect of the invention, a record's employee or a client having access to a client interface may access audit information to confirm whether or not ROIs have been released, accessed by a requesting party, the duration of access, the accessing parties identity, whether or not the ROI was printed, etc. To this end, referring again to FIG. 10, an AUDIT TRAIL icon 403 is provided that is selectable to access audit information corresponding to the ROI presented.

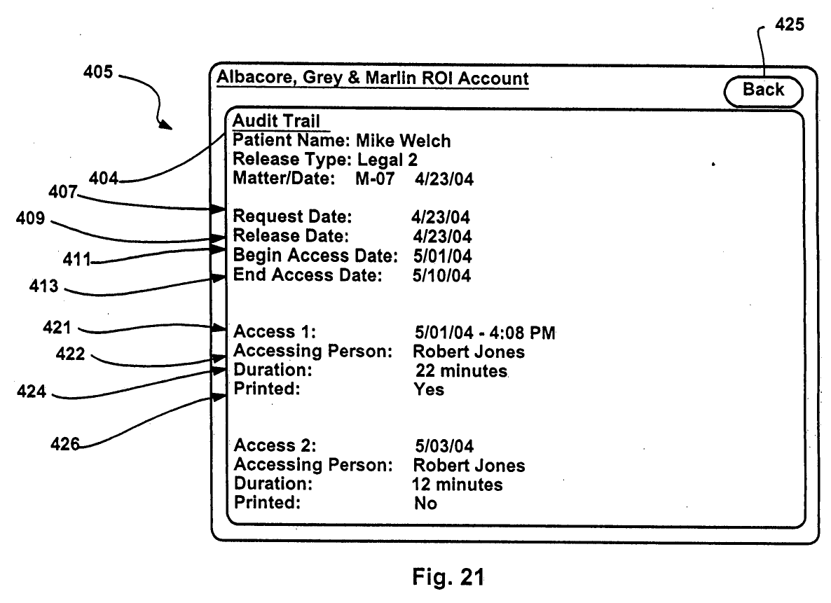

Referring to FIG. 21, an exemplary audit trail window 405 is illustrated that indicates patient and matter information 404, request date 407, release date 409, begin and end access dates 411 and 413, respectively, and a subset of information for each access instance (e.g., two instances illustrated). Each information subset includes an access date 421, a person identifier 422, an access duration indicator 424 and a printed indicator 426. A BACK icon 425 is provided via window 405 for the client to return to the ROI associated with an audit trail.

Referring again to FIG. 7, an AUDIT TRAIL icon 234 is also provided via window 218 in at least some embodiments that is useable by a records employee to access a window similar to window 405 to confirm release and access information.

According to one other aspect of the present invention, a hybrid system is contemplated whereby a ROI requesting party may submit an ROI request directly to server 12 in FIG. 1 and the server may then require final submission of the ROI request by a records employee after the records employee affirms that the request information is accurate and appropriate. To this end, referring to FIG. 22, a subprocess 430 which may be combined with separate portions of the processes of FIGS. 4 and 17 is illustrated. Referring also to FIG. 17, after block 324, control of server 12 may pass to block 430 in FIG. 22 where the request information submitted by a requesting party is provided to the employee interface 14 (see again FIG. 1) along with a release tool. Here, in at least some embodiments, it is contemplated that the request information and the release tool would be provided in the form of a window similar to window 218 illustrated in FIG. 7 where the information specified by the client would be filled into the window fields. After block 430, control passes to block 157 in FIG. 4 where the process described above with respect to FIG. 4 continues. Thus, in this case, the ROI request specification is streamlined and performed by the client, authorization is verified by a records employee and ROI delivery is facilitated via a secure account maintained by server 12.

According to still one additional aspect of the present invention, if a ROI is mistakenly posted by a records employee, the employee can revoke access to the posted ROI thereby limiting the effect of the inadvertently released information. To this end, referring to FIG. 23, a ROI window 411 is illustrated that is similar to the window of FIG. 7, except that the Authorization field 260 indicates “Release Authorized” and the status field 261 indicates “Released”. In addition, when an ROI is viewed after being released, a REVOKE icon 417 is provided in tool bar 222 which, when selected, allows the records employee to revoke access to the ROI.

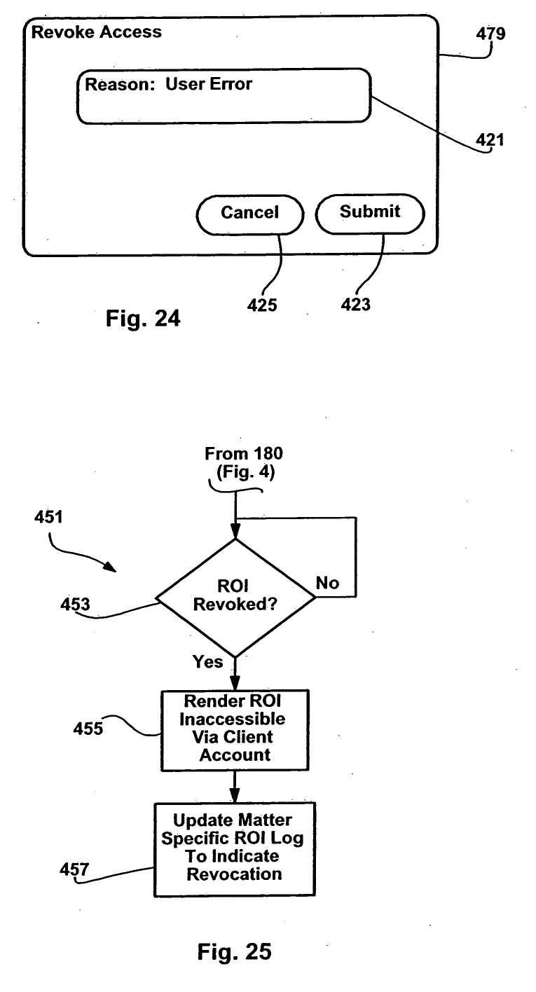

When icon 417 is selected, the revoke access window 479 illustrated in FIG. 24 is provided for the employee. The employee can fill in a reason for revocation in field 421 and select SUBMIT icon 423 to revoke access. CANCEL icon 425 is selectable to return to the window 411 of FIG. 23. Although not illustrated, when a ROI is revoked, the access log may be updated accordingly.

Referring to FIG. 25, a subprocess 451 that may be added to the process of FIG. 4 is illustrated that can be used to implement the revoke function. Referring also to FIG. 4, after a ROI is posted and an e-mail notice is transmitted at block 180, control passes to block 453 in FIG. 25 where server 12 monitors the employee interface 14 for a revoke command. If a revoke command is received control passes to block 455 where server 12 renders the previously posted record inaccessible and at block 457 the matter specific ROI log 370 (see FIG. 13) is updated (not illustrated) to indicate that the record has been revoked.

According to yet one other aspect of the present invention, clients may also be provided with the ability to revoke access to an erroneously posted ROI. In the regard, it is contemplated that most of the time the client, and not the records employee, will know if a record is erroneously posted and that the client will likely be able to determine that the record was erroneously posted prior to accessing particularly sensitive information in the ROI. For instance, if Attorney Jones requests a ROI associated with patient Welch but receives one for patient Donahue, Attorney Jones should be able to determine that an error occurred when reviewing basic ROI information such as the patient name. This, coupled with the fact that systems will likely have auditing and access tracking capabilities and that clients will likely be aware of access tracking capabilities should lead to clients revoking their own access to ROIs posted in error.

Referring to FIG. 9, in at least some embodiments where clients can revoke access, separate REVOKE ACCESS icons 461, 463, etc. will be provided for each ROI on the initial account window that are selectable to revoke access. Again, when one of the icons 461 or 463 is selected, a revoke access window similar to window 479 in FIG. 24 may be provided to the client for revoking purposes.

While the invention may be susceptible to various modifications and alternative forms, specific embodiments have been shown by way of example in the drawings and have been described in detail herein. However, it should be understood that the invention is not intended to be limited to the particular forms disclosed. For example, in at least some cases it is contemplated that, when an e-mail is transmitted to a requesting party indicating that an ROI has been released or posted for the party's access, a notice may be posted on a patient's server maintained account indicating that the ROI has been posted. This additional process step is identified by block 182 in FIG. 4. When an ROI notice is posted for a patient, in at least some cases, an e-mail may be transmitted to the patient requesting that the patient access the patient account to obtain information regarding the ROI.

In addition, referring once again to FIG. 4, the secondary function at block 162 may, in at least some cases, include the subprocess of FIG. 20 where authorization to release an ROI is automatically sought by server 12 when authorization has not been previously obtained.

Moreover, while information subsets may be cobbled together prior to release and posting for access by a client, in at least some cases it is contemplated that the substantive information in the ROI may only be accessed when a client accesses the ROI. Here, while the ROI would be posted in an abbreviated form on a clients account suitable to distinguish one ROI from others no other information would be posted until the client selects the abbreviated ROI identifier. When the abbreviated identifier is selected server 12 would access the current information subsets associated therewith as well as the appropriate ROI type format and generate up to the second release. Here the advantage is that clients can obtain current information which is updated regularly.

In at least some cases it is contemplated that when an e-mail notice is sent to a client indicating that an ROI has been posted the e-mail may include reference phrases to either a log-on window for the client's account or, in some cases, directly to an associated ROI. In some cases an agent (e.g., a doctor, nurse, etc.) may act as an agent for a patient to receive authorization requests and notices of ROI via an interface.

Furthermore, while the inventive concepts are described above in the context of a system wherein a processor associated with the RCE performs most of the process steps, it should be appreciated that it is contemplated that a distributed architecture may also be used and in many cases would be preferred wherein at least some sub-processes would be performed by other than the RCE associated server. Thus, for instance, a clients interface may include at least some processing power and may run interfacing programs for entering requests and for displaying electronically posted records.

Moreover, in some embodiments it is contemplated that a RCE may not want even records employees to be able to examine at least some information in at least some records. Here, it is contemplated that when a record is requested and is retrieved by a records employee prior to electronically sending the record to the requesting party, while the employee's interface may indicate that the record has been retrieved and may provide some record information, the interface may be programmed so that sensitive information is redacted or otherwise not presented in the version of the record accessible by the records employee. In this case, while the records employee cannot access the record information, once the record is posted for access by the requester, the posted record may indicate the sensitive information despite the fact that the records employee could not review the information.

In addition, it is contemplated that the inventive system described above could include a “break the glass” concept wherein specific third party requesters could immediately access certain information when an emergency occurs. For instance, if a patient is in a life threatening accident and a physician treating the patient requires immediate access to historical data, the physician may be able to immediately obtain the historical information following identity authentication via an emergency type request.

Furthermore, while the phrase “server account page” is used above to describe the mechanism by which a client can issue a ROI request and can electronically receive posted records, it should be appreciated that the phrase is not limiting and that the present invention contemplates many different ways of electronically posting in a secure fashion for remote access. To this end, the phrase “server account page” is used to refer to any electronically accessible secure account including but not limited to an internet account, a web page or any other prime modality.

Moreover, while records are described above as being posted as essentially finished documents for electronic access, it is contemplated that posting may include posting information from which a requested record could be cobbled together when the record is ultimately accessed by a requesting party. To this end, in at least some embodiments of the invention it is contemplated that health information will be stored as information subsets as described above and, when a record is electronically posted, the act of posting will include simply providing a data construct including a record format and pointers that point to specific information in the database. Here, when the posted record is selected for access by a client, the system uses the format and the pointers to identify information required to instantiate the record and then provides the record to the client. Importantly, this embodiment allows the record content to be updated even after the posting date so that record information is most current whenever accessed by the client.

Thus, the invention is to cover all modifications, equivalents, and alternatives falling within the spirit and scope of the invention as defined by the following appended claims.

To apprise the public of the scope of this invention, the following claims are made:

What is claimed is:

1. A method for a health care provider to release health information in the form of a health record to at least one third party requester where the requester employs a requester's information interface linkable via a communication network to access health record information from a server associated with the health care provider, the method comprising the steps of:
(a) receiving a release of information (ROI) request from a third party requester requesting information associated with a specific patient;
(b) identifying a record including information requested via the ROI request;
(c) posting the identified record on the network server for access by the at least one third party requester; and
(d) notifying the at least one third party requester that the posted record has been posted for access.

2. The method of claim 1 wherein the step of receiving an ROI request includes receiving a request over the network that is entered via the requester's interface.

3. The method of claim 2 wherein the step of receiving includes providing a record request site via the server that is accessible by the requester via the requester's interface.

4. The method of claim 3 wherein the step of providing a request site includes the step of providing at least one authorization page requiring the requester to enter identifying information prior to entering request information.

5. The method of claim 4 further including the steps of storing site user information indicating third party requesters that are authorized to obtain records via the site, when a requester enters identifying information, comparing the entered information with the user information, when the requester information matches information in the user information, providing a request page for entering the ROI request information.

6. The method of claim 5 for use with several different requester types wherein each type is authorized to access a different record type wherein the step of storing site user information includes storing user type along with user identifying information for each user.

7. The method of claim 6 wherein the step of providing a request page includes providing request pages that are different for each of the third party requester types.

8. The method of claim 6 wherein, after the ROI request is entered, the step of identifying a record including the information requested includes the steps of identifying the requester type and identifying the record including the requested information as a function of the requester type.

9. The method of claim 1 wherein the step of posting the identified record includes providing a separate server account page for each of the third party requesters and posting the record for access on the requester's account page.

10. The method of claim 9 wherein the requester may generate more than one ROI request and wherein the step of posting the record on the account page includes providing a list of posted records for the requester on the account page, each list entry including a reference phrase which, when selected, links the third party requester to an associated record.

11. The method of claim 1 wherein the step of notifying the requester includes transmitting an e-mail to the requester indicating that a record has been posted.

12. The method of claim 11 wherein the step of transmitting includes transmitting an e-mail message including at least some reference phrase that, when selected, links the requester to the server.

13. The method of claim 12 wherein the step of transmitting a message including a reference phrase includes transmitting a reference phrase that links the requester to the requester's account page.

14. The method of claim 12 wherein the step of transmitting a message including a reference phrase includes transmitting a reference phrase that links directly to the record including the requested information.

15. The method of claim 1 wherein the step of posting includes posting the identified record for a predetermined period, the method further including the step of, after the record has been posted for the predetermined period, rendering the record inaccessible to the third party requester.

16. The method of claim 2 further including the step of, when an ROI request is received, storing an indication of the request.

17. The method of claim 2 wherein a notice is generated indicating a request has been made and the notice is provided to one of the requesting party and a patient associated with the ROI.

18. The method of claim 17 wherein the step of storing an indication includes, for at least each record requested, generating an access log indicating instances of associated ROI requests.

19. The method of claim 18 wherein the step of storing an indication includes storing the time of the request.

20. The method of claim 18 wherein the ROI request indicates the identity of the requester and the step of storing an indication includes storing the identity of the requester.

21. The method of claim 20 wherein the step of storing also includes storing the time at which the request was received.

22. The method of claim 1 further including the step of, when a record is posted, storing an indication of the posting.

23. The method of claim 22 wherein the step of storing an indication includes, for at least each record posted, generating an access log indicating instances of associated posted records.

24. The method of claim 22 wherein the step of storing an indication includes storing the time of the posting.

25. The method of claim 22 wherein the ROI request indicates the identity of the requester and the step of storing an indication includes storing the identity of the requester for which the record has been posted.

26. The method of claim 25 wherein the step of storing also includes storing the time at which the record was posted.

27. The method of claim 1 further including the step of, after posting the record, monitoring access to the posted record.

28. The method of claim 27 wherein the step of monitoring includes, whenever the requester accesses the posted record, storing an indication that the record was accessed.

29. The method of claim 28 wherein the step of storing an indication includes, for at least each record accessed, generating an access log indicating instances of associated record access.

30. The method of claim 28 wherein the step of storing an indication includes storing the time at which the record is accessed.

31. The method of claim 28 wherein the step of storing an indication includes storing the identity of the requester that accesses the record.

32. The method of claim 31 wherein the step of storing also includes storing at least one of the time at which the record is accessed and the duration over which the record is accessed.

33. The method of claim 5 wherein only a subset of third party requesters is authorized to access at least one record and wherein the method further includes the step of, prior to posting a record including information requested, determining if the requester is authorized to access the record including information in the ROI request.

34. The method of claim 33 further including the steps of, when a requester requests a record that the requester is not authorized to access, performing a secondary function.

35. The method of claim 34 wherein the step of performing a secondary function includes generating a reject notice indicating that the requester is not authorized to access the requested record.

36. The method of claim 35 further including the steps of, for each record, providing an access log and storing at least an indication of each reject notice associated with the record in the access log.

37. The method of claim 35 wherein the reject notice indicates at least a subset of the identity of the rejected requester and the time of the request.

38. The method of claim 35 wherein at least one employee of the health care provider also has access to an employee's information interface linkable to the server and wherein the reject notice is provided to at least one of the requester via the requester's information interface and the at least one employee via the employee's interface.

39. The method of claim 38 wherein, when the reject notice is provided to the employee, the method further includes the step of enabling the employee to authorize release of the record requested by the ROI request and when the employee releases the record including the information requested, posting the record for access by the requester via the requester's interface.

40. The method of claim 39 wherein the step of enabling includes requiring the employee to indicate the source of authorization via the employee's information interface and storing the source of authorization.

41. The method of claim 34 wherein at least one of the patient associated with the information sought via the ROI request and an agent for the patient has access to a patient's information interface that is linkable to the server associated with the health care provider and wherein the secondary function includes seeking authorization to release the information requested via the ROI request from the at least one of the patient and the agent via the patient's interface.

42. The method of claim 41 wherein the step of seeking authorization includes the step of generating an authorization request to the at least one of the patient and the agent to request authorization.

43. The method of claim 42 wherein the authorization request indicates the time the ROI request was made and the identity of the third party requester.

44. The method of claim 42 further including the steps of, after generating the authorization request, monitoring for a return authorization from the at least one of the patient and the agent, when a return authorization is received, storing the authorization and posting the record including the information requested for access by the requester via the requester's interface.

45. The method of claim 1 wherein at least one of the patient associated with the information sought via the ROI request and an agent for the patient has access to an patient's information interface that is linkable to the server associated with the health care provider and wherein, when a record is posted for access by the requester, the method includes the step of transmitting a release notice to the at least one of the patient and the agent indicating that the record has been released.

46. The method of claim 45 wherein the release notice indicates at least a subset of the time at which the record was released, the identity of the requester and the information in the record that was released.

47. The method of claim 1 wherein the third party requester is one of an insurance company, a health care entity, a legal entity, a government entity, an auditor, a regulatory agency, a consultant and a law enforcement agency.

48. The method of claim 1 wherein at least one employee of the health care provider has access to an employee's information interface linkable to the server and wherein the method further includes the steps of, prior to posting at least some information for access via the requester's interface and after a record is identified, posting at least some information related to the record to the employee's interface and requesting a release authorization from the employee to affirmatively authorize release of the record to the requester and posting the record for access by the requester after the release authorization is received.

49. The method of claim 48 wherein at least one of the patient associated with the information sought via the ROI request and an agent for the patient has access to an patient's information interface that is linkable to the server, the method further including the steps of enabling the employee to seek authorization to release the information requested via the ROI request from the at least one of the patient and the agent via the patient's interface.

50. The method of claim 49 wherein the step of seeking authorization includes the step of generating an authorization request to the at least one of the patient and the agent to request authorization.

51. The method of claim 50 further including the steps of, after generating the authorization request, monitoring for a return authorization from the at least one of the patient and the agent and, when a return authorization is received, storing the authorization.

52. The method of claim 1 wherein the step of posting includes generating an electronic version of the identified record and rendering the electronic version accessible to the requester.

53. The method of claim 52 wherein the step of generating an electronic version includes scanning a hardcopy of the identified record into a computer system.

54. The method of claim 1 wherein the step of posting includes printing out a copy of the record to be one of mailed and faxed to the third party requester.

55. The method of claim 1 wherein the health information is stored as sub-sets of information and the server has access to record formatting information indicating several record formats, the step of identifying a record including identifying a format associated with a requested record and pointers to the sub-sets of information to be used to instantiate the record, the step of posting including posting an indication of the requested record and associating the posting with the format and the pointers.

56. The method of claim 55 further including the step of monitoring for selection of the posted indication by the third party requester and, when the posted indication is selected, using the associated format and the pointers to create the record and rendering the record accessible to the requester.

57. The method of claim 1 wherein the ROI request is processed, authorized and posted for the third party requester automatically.

58. A method for a health care provider to release health information in the form of a health record to third party requesters where the requesters employ requester's information interfaces linkable via a communication network to access health record information from a server associated with the health care provider, the method comprising the steps of:
(a) for each requester, providing a separate account page via the server accessible only by the requester associated with the account for which the page is provided; and
(b) for each account page, posting health records requested by the requester 10 associated with the account.

59. The method of claim 58 wherein the step of posting includes providing a reference phrase that, when selected, renders a record associated therewith accessible to the requester.

60. The method of claim 58 further including the step of, after a record is posted, monitoring the requester's account for access to the posted record.

61. The method of claim 60 wherein the step of monitoring includes, whenever the requester accesses the posted record, storing an indication that the record was accessed.

62. The method of claim 61 wherein the step of storing an indication includes, for at least each record accessed, generating an access log indicating instances of associated record access.

63. The method of claim 62 wherein the step of storing an indication includes storing the time at which the record is accessed.

64. The method of claim 62 wherein the step of storing an indication includes storing the identity of the requester that accesses the record.

65. The method of claim 64 wherein the step of storing also includes storing at least one of the time at which the record is accessed and the duration over which the record is accessed.

66. The method of claim 58 wherein the step of posting records includes providing a list of posted records for the requester on the account page, each list entry including a reference phrase which, when selected, links the third party requester to an associated record.

67. The method of claim 58 further including the step of, when a record is posted on an account page, notifying the requester that the record has been posted.

68. The method of claim 67 wherein the step of notifying includes transmitting an e-mail to the requester indicating that the record has been posted.

69. The method of claim 58 wherein the step of posting includes posting each record for a predetermined period, the method further including the step of, after a record has been posted for the predetermined period, rendering the record inaccessible to the third party requester.

70. The method of claim 58 further including the step of, when a record is posted, storing an indication of the posting.

71. The method of claim 70 wherein the step of storing an indication includes, for at least each record posted, generating an access log indicating instances of associated posted records.

72. The method of claim 70 wherein the step of storing an indication includes storing the time of the posting.

73. The method of claim 70 wherein the step of storing an indication includes storing the identity of the requester for which the record has been posted.

74. A method for a health care provider to release health information in the form of a health record to a third party requester where the health record is associated with a specific patient, the method comprising the steps of:
(a) receiving a release of information (ROI) request from a third party requester requesting information associated with a specific patient;
(b) identifying a record including information requested via the ROI request;
(c) placing the identified record in an electronic format; and
(d) posting the identified record on a secure network site for access by the requester.

75. The method of claim 74 further including the step of providing at least one server associated with the health care provider that runs a program to provide an ROI request page and at least one information interface accessible by the requester for accessing the request page.

76. The method of claim 75 wherein the step of receiving an ROI request includes the steps of, when a requester accesses the ROI request page, facilitating entry of the ROI request information via the requester's interface and, after the ROI request information has been entered, transmitting the entered information to the server associated with the health care provider.

77. The method of claim 76 further including the step of, prior to posting the record, determining if the requester is authorized to access the information requested and posting the record only if the requester is authorized to access the information requested.

78. The method of claim 77 wherein the step of determining if the requester is authorized includes storing an authorization rule set within a database that can be used to determine if a user is authorized and, when a request is received, accessing and applying the authorization rule set.

79. The method of claim 74 wherein the step of placing the record in an electronic format includes scanning the record into a computer.

80. A method for tracking when a health care record is accessed by a third party requester that receives the record, the method comprising the steps of:
electronically posting a requested health record for access by a third party requester;
monitoring access to the posted health record by the third party requester;
when the record is accessed by the third party requester, identifying at least a subset of the time the record is accessed, the identity of the person accessing the record, the duration of record access and whether or not a hard copy of the record was generated; and
storing at least a subset of the time the record is accessed, the identity of the person accessing the record, the duration of record access and whether or not a hard copy of the record was generated as part of a record access log.

81. The method of claim 80 further including the step of providing a network server associated with the health care provider that manages the record sought by the requester, the step of posting including providing an account for the requester and posting the record requested on the requester's account.

82. The method of claim 80 further including the steps of, prior to posting, receiving a release of information (ROI) request from the third party requester and storing an indication of at least a subset of the time the request was made and the identity of the requester in the access log for the record sought.

83. The method of claim 80 further including the steps of, prior to posting, identifying the record requested, determining if the requester is authorized to receive the requested record and, if the requester is authorized, posting the record.

84. The method of claim 83 further including the step of, when a record is posted, storing an indication of the time when the record is posted.

85. A method for providing notice to a patient when a health record associated therewith is requested by a third party requester where the patient has access to a patient's information interface that is linked to a communication network, the method comprising the steps of:
monitoring when records are requested by a requester; and
when a record associated with a specific patient is requested by a requester, transmitting an indication to the patient's interface indicating the record has been requested.

86. The method of claim 85 further including the steps of determining the identity of the requester and the time of a request and wherein the step of transmitting includes transmitting a message indicating both the time of the request and identity of the requester.

87. A method for generating an access log for health records, the method comprising the steps of:
posting health records for access by third party requesters;
monitoring access to the posted records; and
when a posted record is accessed, storing an indication that the record has been accessed in an access log.

88. The method of claim 87 wherein the step of posting the records for access includes providing a server linked to a communication network and electronically posting the records via the server for remote access using at least one information interface.

89. The method of claim 88 wherein requesters access the records via requester interfaces over the network and wherein the step of monitoring includes monitoring access via the network.

90. The method of claim 87 wherein the step of storing an indication includes determining the times at which records are accessed and storing the times.

91. The method of claim 87 wherein the step of storing an indication includes determining the period during which a record is accessed and storing the period.

92. The method of claim 87 wherein the step of storing an indication includes determining the identity of the requester and storing the requester's identity.

93. A method for generating an access log for health records, the method comprising the steps of:
providing a server for accessing health records via network linked information interfaces;
monitoring for a release of information (ROI) request from a requester requesting information associated with a specific patient; and
when an ROI request is received, storing an indication that information was requested.

94. The method of claim 93 wherein the step of storing includes at least one of storing the time of the request and the identity of the requester.

95. The method of claim 94 wherein the step of storing includes storing both the time of the request and the identity of the requester.
